(19) United States
(12) Patent Application Publication
(10) Pub. No.: US 2024/0092192 A1
(43) Pub. Date: Mar. 21, 2024

(54) RECONFIGURABLE MODULAR BATTERY SYSTEM FOR AN ELECTRIC VEHICLE

(71) Applicant: UT-Battelle, LLC, Oak Ridge, TN (US)

(72) Inventors: Vivek A. Sujan, Oak Ridge, TN (US); David E. Smith, Oak Ridge, TN (US); Richard W. Davies, Oak Ridge, TN (US)

(21) Appl. No.: 18/368,037

(22) Filed: Sep. 14, 2023

Related U.S. Application Data
(60) Provisional application No. 63/407,196, filed on Sep. 16, 2022.

(51) Int. Cl. B60L 53/12; B60L 50/60; H02J 7/02

(52) U.S. Cl. CPC B60L 53/12; B60L 50/66; H02J 7/02; B60L 2210/30; B60L 2210/42

(57) ABSTRACT

A vehicle includes a traction inverter and an electric motor operable to provide motive power for the vehicle based on electrical power received wirelessly from a modular power system.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF INVENTION

The present disclosure relates to the field of electrical vehicles, and more particularly toward battery systems for electrical vehicles.

### BACKGROUND

Conventional electrical vehicles carry an on-board battery that must be recharged frequently in order to maintain operability of the electric vehicle. Because battery technology in its current form does not include significant energy density or fast recharge capabilities, the range of a conventional electric vehicle is limited relative to the range of a conventional internal combustion engine (ICE) based vehicle.

A variety of solutions have been proposed for overcoming the disadvantages of conventional battery technology in electrical vehicles. One conventional solution involves a modular battery concept that requires removal of a modular battery by disconnecting a physical, electrical connection between the vehicle and the modular battery, and installation of a new modular battery by providing a physical electrical connection between the vehicle and the modular battery. This type of solution enables the vehicle to avoid hauling a battery when not needed (e.g., less range is needed) or to haul additional batteries for increased range. However, this type of conventional modular battery relies on mechanical contact for the electrical connection, resulting in low reliability (e.g., mechanical connector wear) and increased manual labor for installation of the battery. Additionally, the physical electrical connection involves high power cables that increase the overall weight of the system. The use of cables and the physical electrical connection is considered a significant impediment to changing the modular battery for another one.

Conventional solutions also often suffer from a variety of other issues, including fixed sizing and temperature management. For instance, in conventional solutions, the number and type of cells used in the system are substantially the same. This conventional configuration uses the same setup regardless of the use case of the vehicle, i.e., long range and short-range use cases are provided with the same setup.

### SUMMARY

In general, one innovative aspect of the subject matter described herein can be embodied in a modular DC-power source to be placed within, and removed from, a DC-power slot of an electric vehicle (EV) for controlling a range of the EV. The EV may include a DC bus that has a wireless input port associated with the DC-power slot. The wireless input port may be formed from an input wireless-power transfer (WPT) pad electrically coupled with an AC/DC rectifier.

The modular DC-power source may include a DC-power source configured to output first DC power, a high-frequency inverter electrically coupled with the DC-power source and configured to convert the first DC power to high-frequency AC power. The modular DC-power source may include an output WPT pad electrically coupled with the high-frequency inverter and arranged to be located adjacent to, but spaced apart from, the input WPT pad of the wireless input port of the DC bus when the modular DC-power source has been placed within the DC-power slot. The output WPT pad may be configured to wirelessly transmit the high-frequency AC power to the adjacently located input WPT pad to be converted to second DC power by the AC/DC rectifier of the wireless input port, and the second DC power may be provided to the DC bus by the AC/DC rectifier.

The foregoing and other embodiments can each optionally include one or more of the following features, alone or in combination. In particular, one embodiment includes all the following features in combination.

In some embodiments, the DC-power source may be a battery.

In some embodiments, the DC-power source may be a fuel cell.

In some embodiments, the DC-power source may be a DC-power generator that includes an AC-power generator driven by an internal combustion engine to produce AC power. The DC-power generator may include a rectifier electrically coupled to the AC-power generator to convert the AC power to the first DC power that is output by the DC-power source.

In some embodiments, the modular DC-power source may include a frame configured and shaped to encompass the DC-power source at least partially, wherein the output WPT pad may be disposed on one of the sides, top or bottom of the frame.

In general, one innovative aspect of the subject matter described herein can be embodied in a system for controlling range of an electric vehicle (EV). The EV may include a main battery, a traction inverter powered by the main battery through a DC bus, and an electric motor driven by the traction inverter. The system may include one or more modular-battery slots disposed on the EV. The modular-battery slots may include respective wireless input ports, each wireless input port including an input wireless-power transfer (WPT) pad. The system may include an AC/DC rectifier electrically coupled between the input WPT pad and the DC bus. The system may include one or more modular batteries to be placed within, and removed from, corresponding modular-battery slots. Each modular battery may include a battery configured to output first DC power, a high-frequency inverter electrically coupled with the battery and configured to convert the first DC power to high-frequency AC power, and an output WPT pad electrically coupled with the high-frequency inverter and arranged to be located, when the modular battery has been placed within a modular-battery slot, adjacent to, but spaced apart from, the input WPT pad of the wireless input port of the modular-battery slot. The output WPT pad may be configured to wirelessly transmit the high-frequency AC power to the adjacently located input WPT pad.

The foregoing and other embodiments can each optionally include one or more of the following features, alone or in combination. In particular, one embodiment includes all the following features in combination.

In some embodiments, the wireless input ports of the respective modular-battery slots may be connected in parallel to each other and to the DC bus.

In some embodiments, at the wireless input port of each modular-battery slot in which a modular battery has been placed, the AC/DC rectifier may be configured to receive the high-frequency AC power from the input WPT pad, convert the high-frequency AC power to second DC power, and provide the second DC power to the DC bus.

In some embodiments, the wireless input ports of the respective modular-battery slots may be connected in series to each other to form a series circuit. The series circuit may be connected to the DC bus.

In some embodiments, the respective input WPT pads of the wireless input ports may be connected in series with each other to form a series input-WPT-pad circuit. A single AC/DC rectifier may be electrically coupled between the series input-WPT-pad circuit and the DC bus. The AC/DC rectifier may be configured to receive the high-frequency AC power from the series input-WPT-pad circuit, convert the high-frequency AC power to second DC power, and provide the second DC power to the DC bus.

In some embodiments, the modular-battery slots may be stacked vertically or horizontally on the EV.

In general, one innovative aspect of the subject matter described herein can be embodied in a modular power source to be placed within, and removed from, a power slot of an electric vehicle (EV) for supplying power to the EV. The EV may include a power bus and a wireless power receiver coupled to the power bus. The wireless power receiver may include a receiver electrically coupled to an AC/DC rectifier. The modular power source may include a DC-power source configured to output first DC power, and switching circuitry operably coupled to the DC-power source and configured to convert the first DC power to high-frequency AC power. The modular power source may include a transmitter operably coupled to the switching circuitry and arranged to be located proximal to the receiver of the wireless power receiver with the modular power source positioned in the power slot. The transmitter may be configured to wirelessly transmit the high-frequency AC power to the proximally located receiver to be converted, by the wireless power receiver, to second DC power, where the second DC power may be provided to the power bus by the wireless power receiver.

The foregoing and other embodiments can each optionally include one or more of the following features, alone or in combination. In particular, one embodiment includes all the following features in combination.

In some embodiments, the DC-power source may be a battery.

In some embodiments, the DC-power source may be a fuel cell.

In some embodiments, the DC-power source may be a DC-power generator that includes an AC-power generator driven by an internal combustion engine to produce AC power, and a rectifier operably coupled to the AC-power generator to convert the AC power to the first DC power that is output by the DC-power source.

In some embodiments, the modular power source may include a frame configured to support the DC-power source, the switching circuitry, and the transmitter. The modular power source may include a housing that encloses and hermetically seals the DC-power source, the switching circuitry, and the transmitter.

In some embodiments, the frame may be integral to the housing.

In some embodiments, the transmitter may include a transmitter coil and a flux guide operable to facilitate flux linkage with the receiver of the wireless power receiver, where the flux guide may include an annular recess in which the transmitter coil is disposed.

In general, one innovative aspect of the subject matter described herein can be embodied in a modular power system for an electric vehicle (EV), the EV including a traction inverter operable to receive power via a vehicle power bus and an electric motor driven by the traction inverter. The modular power system may include a module power slot disposed on the EV, the module power slot including a wireless power receiver. The wireless power receiver may include a receiver electrically coupled to rectification circuitry, where the wireless power receiver may be operable to provide power to the vehicle power bus via rectification circuitry.

The modular power system may include a modular power source removably positioned in the module power slot of the EV, where the modular power source may include a DC-power source configured to output module DC power. The modular power source may include switching circuitry operably coupled to the DC-power source and configured to convert the module DC power to high-frequency AC power. The modular power source may include a transmitter operably coupled to the switching circuitry and arranged to be located proximal to the receiver of the wireless power receiver with the modular power source positioned in the module power slot. The transmitter may be configured to wirelessly transmit the high-frequency AC power to the proximally located receiver, where the wireless power receiver may be configured to convert power received from the transmitter to power supplied to the vehicle power bus.

The foregoing and other embodiments can each optionally include one or more of the following features, alone or in combination. In particular, one embodiment includes all the following features in combination.

In some embodiments, the modular power system may include a plurality of the module power slots and a plurality of the modular power sources respectively associated with each of the plurality of the module power slots.

In some embodiments, the wireless power receivers of the module power slots may be coupled in parallel with each other to the vehicle power bus.

In some embodiments, the wireless power receivers of the module power slots may be coupled in series with each other to the vehicle power bus.

In some embodiments, two or more of the wireless power receivers of the plurality of module power slots may be coupled to the same rectification circuitry.

In some embodiments, each of the wireless power receivers may include receiver rectification circuitry, where the receiver rectification circuitry of a first wireless power receiver of the plurality corresponds to the rectification circuitry.

In some embodiments, the DC-power source may be a battery.

In some embodiments, the DC-power source may be a fuel cell.

In general, one innovative aspect of the subject matter described herein can be embodied in a modular DC-power source to be placed within, and removed from, a DC-power slot of an electric vehicle (EV) for controlling a range of the EV. The EV may include a DC bus that has a wireless input port associated with the DC-power slot. The wireless input port may be formed from an input wireless power transfer (WPT) pad electrically coupled with an AC/DC rectifier.

The modular DC-power source may include a DC-power source configured to output first DC power, and a high-frequency inverter electrically coupled with the DC-power source and configured to convert the first DC power to high-frequency AC power.

The modular DC-power source may include an output WPT pad electrically coupled with the high-frequency inverter and arranged to be located adjacent to, but spaced apart from, the input WPT pad of the wireless input port of the DC bus when the modular DC-power source has been placed within the DC-power slot. The output WPT pad may be configured to wirelessly transmit the high-frequency AC power to the adjacently located input WPT pad to be converted to second DC power by the AC/DC rectifier of the wireless input port. The second DC power may be provided to the DC bus by the AC/DC rectifier.

The modular DC-power source may include a power conditioning subsystem configured to regulate the transmitted high-frequency AC power based on, at least in part, the first DC power available to be output by the battery and the DC power provided to the DC bus by the one or more DC power sources coupled to the DC bus.

The foregoing and other embodiments can each optionally include one or more of the following features, alone or in combination. In particular, one embodiment includes all the following features in combination.

The modular DC-power source may include a thermal management subsystem with an integrated cooling system configured to reject heat released by components of the modular battery and by the one or more DC power sources coupled to the DC bus.

In some embodiments, the DC-power source may be a battery.

In some embodiments, the DC-power source may be a fuel cell.

In some embodiments, the DC-power source may be a DC-power generator that includes: an AC-power generator driven by an internal combustion engine to produce AC power, and a rectifier electrically coupled to the AC-power generator to convert the AC power to the first DC power that is output by the DC-power source.

In some embodiments, the DC-power source may be a DC-power generator that includes: an AC-power generator driven by an internal combustion engine to produce AC power, and a rectifier electrically coupled to the AC-power generator to convert the AC power to the first DC power that is output by the DC-power source.

In some embodiments, the modular DC-power source may include a frame configured and shaped to encompass the DC-power source at least partially, wherein the output WPT pad is disposed on one of the sides, top, or bottom of the frame.

In some embodiments, the modular DC-power source may include a module management subsystem configured to control operation of the high-frequency inverter and operation of at least one of the power conditioning subsystem and a thermal management subsystem.

In general, one innovative aspect of the subject matter described herein can be embodied in a pack comprising:

two or more modular batteries according to one embodiment described herein, the modular batteries being at least some of the DC power sources coupled to the DC bus to provide DC power thereto. Each module management subsystem of a respective modular battery of the pack may be configured to communicate with module management subsystems of remaining modular batteries that are currently part of the pack.

The pack may include a pack management subsystem communicatively coupled with the module management subsystems of the modular batteries that are currently part of the pack. The pack management subsystem may be configured to receive modular battery specific telemetric information from the pack's module management subsystems, issue, based on the modular battery specific telemetric information received on a collective basis, commands for operating the pack's module batteries, and transmit the commands on an individual basis to the pack's module management subsystems.

The foregoing and other embodiments can each optionally include one or more of the following features, alone or in combination. In particular, one embodiment includes all the following features in combination.

In some embodiments, the modular battery specific telemetric information may include state of health, state of charge and state of power. The pack management subsystem may be configured to: determine state of health, state of charge and state of power for the pack, and issue the commands using the determined pack specific information.

In some embodiments, to determine the pack specific information, the pack management subsystem may be configured to combine the modular battery specific telemetric information.

In some embodiments, the pack may include at least one fixed battery module that is coupled to the DC bus, in a manner that renders the fixed battery module un-swappable, to provide DC power thereto, where the fixed battery module may include a rechargeable battery.

In some embodiments, a reconfigurable electrical energy storage system (EESS) may be disposed onboard a vehicle. The EESS may include two or more packs, the modular batteries of the packs being the DC power sources coupled to the DC bus to provide DC power thereto. Each pack management subsystem of a respective pack of the EESS may be configured to communicate with pack management subsystems of remaining packs that are currently part of the EESS. An EESS management subsystem may be communicatively coupled with the pack management subsystems of the packs that are currently part of the EESS. The EESS management subsystem may be configured to: receive pack specific information from the EESS' pack management subsystems, issue, based on the pack specific information received on a collective basis, commands for operating the EESS' packs, and transmit the commands on an individual basis to the EESS' pack management subsystems.

In general, one innovative aspect of the subject matter described herein can be embodied in a modular DC-power source to be placed within, and removed from, a DC-power slot of an electric vehicle (EV) for controlling a range of the EV. The EV may include a DC bus that has a wireless input port associated with the DC-power slot. The wireless input port may be formed from an input wireless power transfer (WPT) pad electrically coupled with an AC/DC rectifier. The modular DC-power source may include a DC-power source configured to output first DC power, and a high-frequency inverter electrically coupled with the DC-power source and configured to convert the first DC power to high-frequency AC power.

The modular DC-power source may include an output WPT pad electrically coupled with the high-frequency inverter and arranged to be located adjacent to, but spaced apart from, the input WPT pad of the wireless input port of the DC bus when the modular DC-power source has been placed within the DC-power slot. The output WPT pad may be configured to wirelessly transmit the high-frequency AC power to the adjacently located input WPT pad to be converted to second DC power by the AC/DC rectifier of the wireless input port. The second DC power may be provided to the DC bus by the AC/DC rectifier.

The modular DC-power source may include a thermal management subsystem with an integrated cooling system configured to reject heat released by components of the modular battery and by the one or more DC power sources coupled to the DC bus.

The foregoing and other embodiments can each optionally include one or more of the following features, alone or in combination. In particular, one embodiment includes all the following features in combination.

In some embodiments, the modular DC-power source may include a power conditioning subsystem configured to regulate the transmitted high-frequency AC power based on, at least in part, the first DC power available to be output by the battery and the DC power provided to the DC bus by the one or more DC power sources coupled to the DC bus.

In some embodiments, the DC-power source may be a battery.

In some embodiments, the DC-power source may be a fuel cell.

In some embodiments, the DC-power source may be a DC-power generator that includes: an AC-power generator driven by an internal combustion engine to produce AC power, and a rectifier electrically coupled to the AC-power generator to convert the AC power to the first DC power that is output by the DC-power source.

In some embodiments, the modular DC-power source includes a frame configured and shaped to encompass the DC-power source at least partially, where the output WPT pad is disposed on one of the sides, top or bottom of the frame.

In some embodiments, the modular DC-power source may include a module management subsystem configured to control operation of the high-frequency inverter and operation of at least one of the power conditioning subsystem and a thermal management subsystem.

In general, one innovative aspect of the subject matter described herein can be embodied in a pack comprising: two or more modular batteries according to one or more embodiments described herein. At least some of the DC power sources coupled to the DC bus to may provide DC power thereto. Each module management subsystem of a respective modular battery of the pack may be configured to communicate with module management subsystems of remaining modular batteries that are currently part of the pack.

The pack may include a pack management subsystem communicatively coupled with the module management subsystems of the modular batteries that are currently part of the pack. The pack management subsystem may be configured to: receive modular battery specific telemetric information from the pack's module management subsystems, issue, based on the modular battery specific telemetric information received on a collective basis, commands for operating the pack's module batteries, and transmit the commands on an individual basis to the pack's module management subsystems.

The foregoing and other embodiments can each optionally include one or more of the following features, alone or in combination. In particular, one embodiment includes all the following features in combination.

In some embodiments, the modular battery specific telemetric information may include state of health, state of charge and state of power, and the pack management subsystem may be configured to: determine state of health, state of charge and state of power for the pack, and issue the commands using the determined pack specific information.

In some embodiments, to determine the pack specific information, the pack management subsystem may be configured to combine the modular battery specific telemetric information.

In some embodiments, at least one fixed battery module may be is coupled to the DC bus, in a manner that renders the fixed battery module un-swappable, to provide DC power thereto. The fixed battery module may include a rechargeable battery.

In general, one innovative aspect of the subject matter described herein can be embodied in a reconfigurable electrical energy storage system (EESS) to be disposed onboard a vehicle. The EESS may include two or more packs according to one or more embodiments described herein. The modular batteries of the packs may include the DC power sources coupled to the DC bus to provide DC power thereto. Each pack management subsystem of a respective pack of the EESS may be configured to communicate with pack management subsystems of remaining packs that are currently part of the EESS. An EESS management subsystem may be communicatively coupled with the pack management subsystems of the packs that are currently part of the EESS. The EESS management subsystem may be configured to: receive pack specific information from the EESS' pack management subsystems, issue, based on the pack specific information received on a collective basis, commands for operating the EESS' packs, and transmit the commands on an individual basis to the EESS' pack management subsystems.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 shows a vehicle in one embodiment according to the present disclosure.

FIG. 2 shows another vehicle in one embodiment according to the present disclosure.

FIG. 3 shows a modular power source in accordance with one embodiment.

FIG. 4 shows an equivalent circuit configuration of the modular power source in FIG. 3.

FIG. 5 shows a perspective view of the modular power source of FIG. 3.

FIG. 6 shows a representative view of a vehicle according to one embodiment.

FIG. 7 shows a representative view of a vehicle according to one embodiment.

FIG. 8 shows a representative view of a vehicle according to one embodiment.

FIG. 9 shows a representative schematic of a vehicle according to one embodiment.

FIG. 10 shows a modular power system in one embodiment according to the present disclosure.

FIG. 11 shows a modular power system in one embodiment according to the present disclosure.

FIG. 12 shows a representative schematic of the modular power system in one embodiment according to the present disclosure.

FIG. 13 shows a representative schematic of a modular power system in an alternative embodiment according to the present disclosure.

FIG. 14 shows a perspective view of a wireless receiver and a wireless transmitter in one embodiment.

FIG. 15 shows another perspective view of the wireless receiver and the wireless transmitter of FIG. 14.

FIG. 16 shows a representative view of a wireless receiver and a wireless transmitter according to one embodiment.

FIG. 17 shows a sectional view of FIG. 15.

FIG. 18 shows another sectional view of FIG. 15.

FIG. 19 shows magnetic field emission with respect to the wireless receiver and the wireless transmitter of FIG. 15.

FIG. 20 shows magnetic flux density with respect to the wireless receiver and the wireless transmitter of FIG. 15.

FIG. 21 shows a method of swapping modular power sources in one embodiment according to the present disclosure.

FIG. 22 shows a representative schematic of the modular power source and a wireless input port in one embodiment.

FIG. 23 shows an equivalent circuit for a wireless transmitter and a wireless receiver in one embodiment according to the present disclosure.

FIG. 24 shows a modular power system according to one embodiment.

FIG. 25 shows the modular power system of FIG. 24 incorporated into a vehicle according to one embodiment.

FIG. 26 shows an electric energy storage system for a vehicle according to one embodiment.

FIG. 27 shows an electric energy storage system for a vehicle according to one embodiment.

FIG. 28 shows an electric energy storage system for a vehicle according to one embodiment.

FIG. 29 shows a conventional electrical energy system.

FIG. 30 shows a modular and reconfigurable electric energy storage system for a vehicle according to one embodiment.

FIG. 31 shows a modular and reconfigurable electric energy storage system for a vehicle according to one embodiment.

FIG. 32 shows a module for an electric energy storage system for a vehicle according to one embodiment.

FIG. 33 shows a module for an electric energy storage system for a vehicle according to one embodiment.

FIG. 34 shows a module for an electric energy storage system for a vehicle according to one embodiment.

FIG. 35 shows a control system for an electric energy storage system for a vehicle according to one embodiment.

FIG. 36A shows a control system for an electric energy storage system for a vehicle according to one embodiment.

FIG. 36B shows a control system for an electric energy storage system for a vehicle according to one embodiment.

FIG. 37 shows a method of operation according to one embodiment.

FIG. 38 shows a plot of power usage in a system for a vehicle according to one embodiment.

FIG. 39 shows a control architecture for a system for a vehicle according to one embodiment.

FIG. 40 shows a method of operation according to one embodiment.

### DETAILED DESCRIPTION

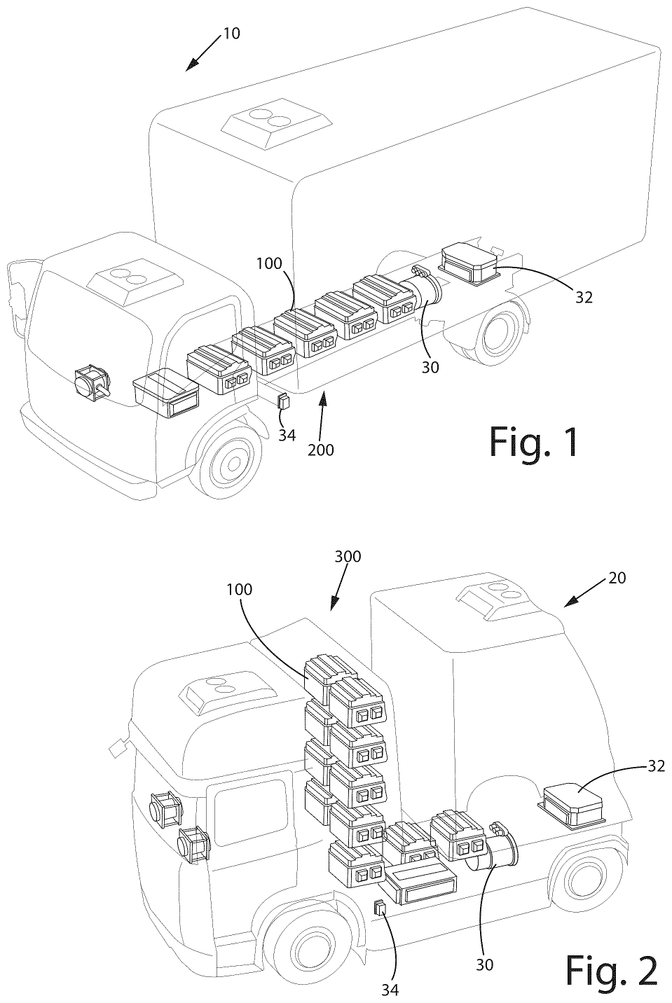

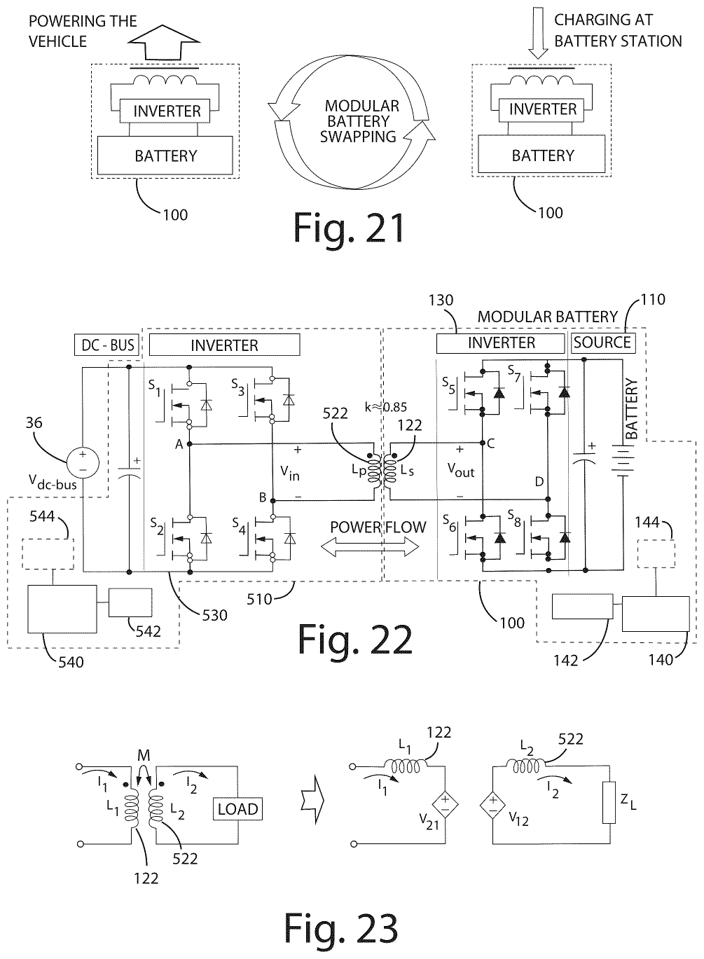

A vehicle in accordance with one embodiment is shown in FIG. 1 and designated 10. The vehicle 10 includes traction inverter 32 and an electric motor 30 operable to provide motive power for the vehicle based on electrical power received wirelessly from a modular power system 200. The vehicle 10 may include a charge system 34, which may operate as an onboard charger, including a charge port configured to receive power from an external supply and charge circuitry operable to supply power received by the charge port to charge one or more batteries of the modular power system 200 or an onboard battery 38 of the vehicle 10, or both. The traction inverter 32 may be operable to convert DC power from the modular power system 200 or a battery 38 of the vehicle 10, or both, to supply AC power to the electric motor 30 in order to generate motive power for the vehicle 10. In the illustrated embodiment, the vehicle 10 includes a modular power system 200 operable to accept and receive power from a plurality of modular power sources 100 arranged along a longitudinal axis of the vehicle 10 and respectively disposed in a plurality of slots. The modular power system 200 may include a plurality of wireless receivers respectively associated with each of the plurality of slots and modular power sources 100. In one embodiment, a modular power source 100 may be removably placed within a slot and operable to transfer power to the vehicle absent any physical electrical connector between the modular power source 100 and the vehicle. As depicted in the illustrated embodiment of FIG. 21, the modular power source may be placed within the slot for transfer of power to aspects of the vehicle, and may be removed from the vehicle for charging purposes at a charging station. The modular power source 100 may be operable to receive power wirelessly from the charging station in order to recharge a battery of the modular power source 100. After the battery of the modular power source 100 has been recharged, the modular power source 100 may be installed again in an electric vehicle, perhaps the same or a different electric vehicle. The process of removing or installing (or both) the modular power source may be conducted in an automated manner without human intervention. Alternatively, a human operator may facilitate removal or installation, or both, of the modular power source 100 in the vehicle 10.

The modular power system 200 in one embodiment may facilitate coupling a battery of the modular power source 100 to the drivetrain of the vehicle via a wireless coupling, which does not rely on physical electrical contacts for swapping one modular power source 100 for another. Elimination of mechanical contacts or direct electrical contacts increases system reliability. Additionally, the modular power system 200 may be utilized in conjunction with a plurality of modular power sources 100, which may enable increased range such as by providing one, two, or more modules.

As described herein, the modular power source 100 is not limited to a battery base configuration. A power source provided in the modular power source may be any type of power source, including in DC-based or AC-based power sources. Examples of such power sources include fuel cells (e.g., hydrogen-based fuel cells) and ICE-based generators. In AC-based power source configurations, a rectifier may be provided with the AC power source (e.g., an ICE-based generator) for conversion to DC power that can be utilized by the inverter 134 transmitting wireless power via the wireless power transmitter 120. In this way, the AC power source configuration may act as a DC power generator. The modular power system 200 is not limited to any particular type of power source technology, and may be adapted for any type of power source.

The modular power system 200, including a plurality of modular power sources 100, may facilitate charge and voltage balancing when a new modular power source 100 is introduced to existing power sources, including other modular power sources 100 or a battery 38 (e.g., an onboard battery), or a combination thereof. For example, the power flow rate from the individual modular power system can be controlled; hence, by controlling the power and current sharing, the voltage, battery state-of-charge, and temperature can be balanced for optimal operation.

It is to be understood that the present disclosure is not limited to the configuration of the modular power system 200 depicted in the illustrated embodiment. For example, an alternative modular power system is shown in FIG. 2 in connection with a vehicle 20, with the modular power system designated 300. The vehicle 20 and the modular power system 300 are configured similar to the vehicle 10 and the modular power system 200, including being operable to accept and receive power from a plurality of the modular power sources 100. The modular power system 300 in the illustrated embodiment is configured to accept and receive power from a plurality of modular power sources 100 arranged in a stacked configuration transverse to the longitudinal axis of the vehicle 20.

Although the vehicle 10, 20 are depicted as tractor trailer type vehicles, it is to be understood that the present disclosure is not so limited and the modular power system 200, 300 may be incorporated into any type of machine operable to transport people or cargo, including wagons, bicycles, motorcycles, cars, trucks, buses, rail vehicles, watercraft, and aircraft.

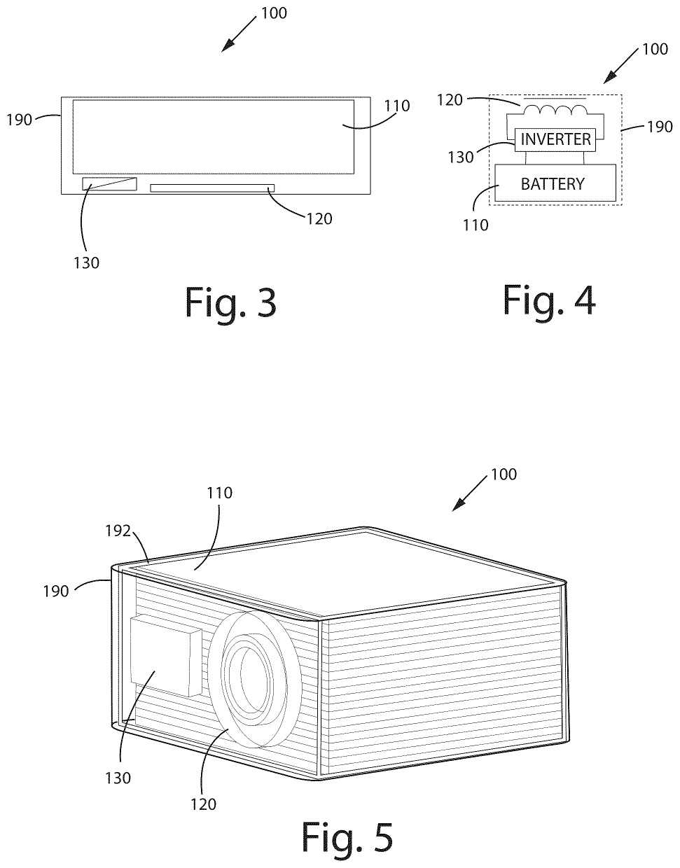

The modular power source 100 in accordance with one embodiment is shown in FIGS. 3 and 5, and a representative view of the modular power source 100 is depicted in FIG. 4. The modular power source 100 in the illustrated embodiment includes a battery 110 and inverter 130, and a wireless power transmitter 120. The modular power source 100 may include an enclosure 190 (e.g., a housing), which is configured to provide galvanic isolation or a hermetic seal against the outside environment, or both. The enclosure 190 may be a fully galvanic and hermetic enclosure that seals the battery 110, the inverter 130, and the wireless power transmitter 120 from the outside environment. The modular power source 100 in one embodiment may include no components external to the enclosure 190, substantially preventing damage to any such components during installation and removal of the modular power source 100 from the vehicle 10, 20. For instance, the modular power source 100 may include no exposed contacts during charging, installation within a vehicle 10, 20, or swapping within a vehicle 10, 20. Additionally, the modular power source may be used in diverse environments or weather conditions, or both.

The modular power system 200 may enable interoperability among a variety of different power sources and vehicles. The modular power system 200 may support modular power sources 100 of different types (at the same time or at different times), and may be provided in any type of vehicle 10, 20.

The modular power sources 100 may be charged separate from the vehicle 10, 20, and may be separate from the vehicle and installed or distributed for use in a vehicle when ready. The modular power source 100 may be charged at a rate that is slow relative to conventional charging systems for onboard batteries of electric vehicles, primarily because the need for fast charging is lesser with respect to modular power sources 100 that can be swapped with a fully charged modular power source 100 after depletion. For instance, the modular power source 100 may be charged overnight, such as for 6 to 8 hours. The charging rate may be between 10 and 50 kilowatts, whereas, in the modular power system 200 of the vehicle 10, 20, the discharge rate may be between 50 and 150 kW.

The modular power source 100 may include a frame 192 operable to support components of the modular power source 100 within the enclosure 190. The frame 192 may also provide support for the enclosure 190. The frame 192 may be a metal structure or a polymer-based structure, or a combination thereof, including an arrangement of elements that form a cuboid structure that can be installed and removed into a slot of the modular power system 200, 300.

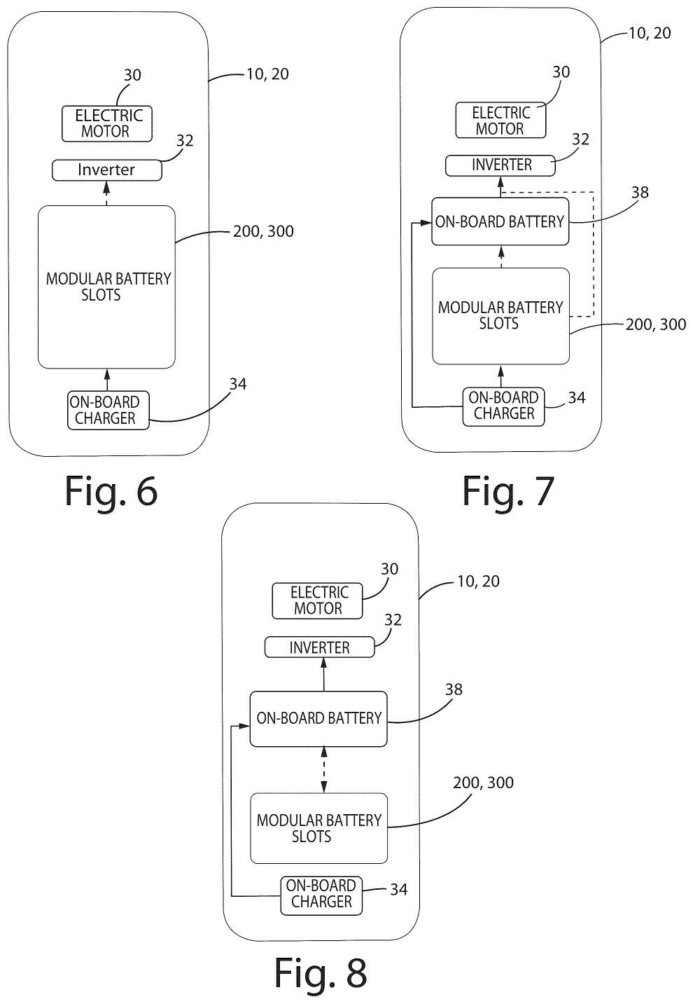

The vehicle 10, 20 may be configured in a variety of ways, as described herein, to utilize power based on the modular power system 200, 300. Example configurations are depicted in the illustrated embodiments of FIGS. 6-8. For instance, in the illustrated body mount of FIG. 6, the vehicle 10, 20 may include the modular power system 200, 300 provided as the sole power source (e.g., the main battery) for the traction inverter 32 and electric motor 30. As described herein, the modular power system 200, 300 may include a plurality of slots configured to accept a plurality of modular power sources 100, and where each modular power source 100 may be readily replaced (e.g., after depletion of the battery 110) with another modular power source 100. Additionally, the charge system 34 may be configured to supply power to one or more of the modular power sources 100 of the modular power system 200, 300, such that the charge system 34 may charge one or more of the modular power sources 100.

The vehicle 10, 20 may be configured differently from the configuration depicted in FIG. 6, such as by including an onboard battery 38 as shown in the illustrated embodiments of FIGS. 7 and 8. The onboard battery 38 may be installed in the vehicle 10, 20 in a manner that is not readily replaceable as compared to the modular power source 100. Power from the onboard battery 38 and the modular power system 200, 300 may be utilized by the vehicle 10, 20 in a variety of ways.

In the illustrated embodiment of FIG. 7, the traction inverter 32 may receive power from the onboard battery 38 and power from the modular power system 200, 300 via the onboard battery 38. Optionally, the traction inverter 32 may receive power from the modular power system 200, 300 separate from the onboard battery 38, such that both the onboard battery 38 and the modular power system 200, 300 may separately provide power directly to the traction inverter 32. In configurations where the modular power system 200, 300 supplies power to the traction inverter 32 via the onboard battery 38, such power may be utilized to charge the onboard battery 38 or alternatively such power may pass through the onboard battery 38 directly to the traction inverter 32. The charge system 34 in the illustrated embodiment of FIG. 7 is operable to separately charge the onboard battery 38 and one or more of the modular power sources 100 of the modular power system 200, 300. As described herein, the modular power source 100 in accordance with one embodiment may be operable to both transmit and receive power wirelessly within the modular power system 200, 300.

Alternatively, as depicted in the illustrated embodiment of FIG. 8, the charge system 34 may be operable to charge the onboard battery 38, which may receive or supply power to the modular power system 200, 300. The modular power system 200, 300 may charge the onboard battery 38 and extend range. The modular power system 200, 300 may include lesser rated wireless couplers and inverters for the modular power system 200, 300 to charge the onboard battery 38.

One or more of the modular power sources 100 of the modular power system 200, 300 in the illustrated embodiment of FIG. 8 may be charged by power received from the onboard battery 38. Conversely, the modular power system 200, 300 may supply power to the onboard battery 38 to charge the onboard battery 38 or supply power to the traction inverter 32, or both.

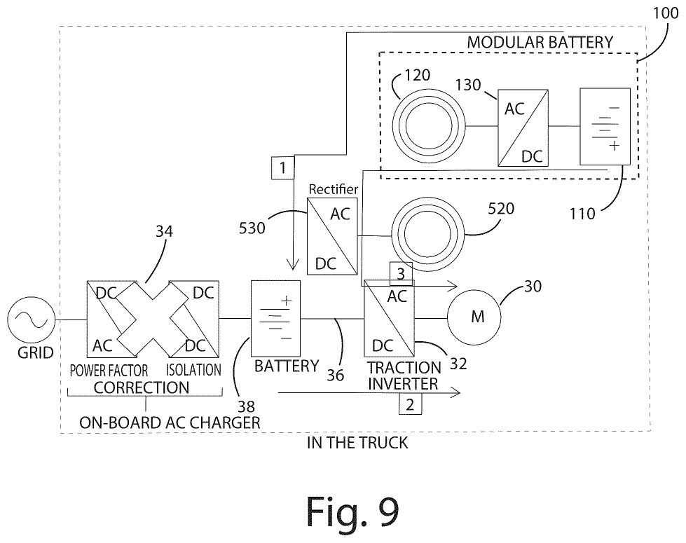

The vehicle configuration in the illustrated embodiment of FIG. 8 is shown in further detail in FIG. 9, including a modular power source 100, a charge system 34, an onboard battery 38, a traction inverter 32, and an electric motor 30. In the illustrated embodiment, the charge system 34 is operable to supply power to the onboard battery 38, which may provide power to the traction inverter 32. The charge system 34 may be operable to receive power from an external source, such as grid power. The charge system 34 in the illustrated embodiment includes an AC/DC converter for power factor correction with respect to power received from the grid, and a DC/DC converter for isolation with respect to power received from the grid. It is to be understood that the charge system 34 may be configured differently, depending on design constraints. The battery 38 may supply power to a vehicle bus 36, and the traction inverter 32 may be coupled to the vehicle bus 36 to receive power therefrom.

The traction inverter 32 in the illustrated embodiment is operable as a DC/AC converter that converts the DC power received via the vehicle bus 36 into AC power that can be supplied to the electric motor 30 to generate torque for the vehicle 10, 20.

The modular power system 200, 300 may include a wireless power receiver 520 operable to receive power transmitted from the wireless power transmitter 120 of the modular power source 100. The modular power system 200, 300 may also include at least one rectifier 530 configured to translate AC power received by the wireless transmitter receiver 520 into DC power that can be supplied to the vehicle bus 36. In this way, power supplied from the rectifier 530 may be provided via the vehicle bus 36 to the traction inverter 32. Additionally, or alternatively, the DC power output from the rectifier 530 to the vehicle bus 36 may be provided to the onboard battery 38 in order to charge the onboard battery 38.

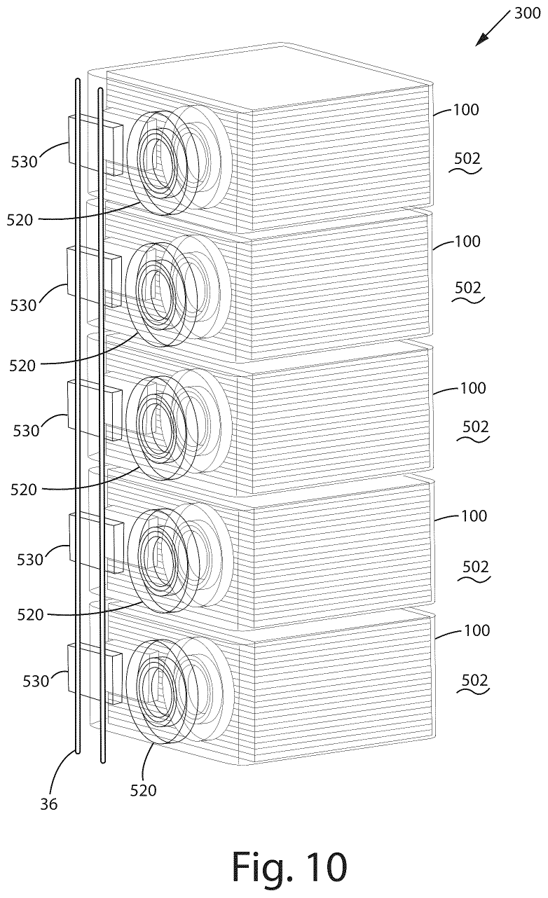

Turning to the illustrated embodiment of FIG. 10, the modular power system 300 is shown in further detail in conjunction with a plurality of slots 502 and a plurality of modular power sources 100. Each of the slots 502 of the modular power system 300 includes a wireless power receiver 520 and a rectifier 530 (e.g., rectification circuitry), which may be coupled to the vehicle bus 36 for supply or receipt of power relative to the vehicle bus 36. The wireless power receiver 520 in the illustrated embodiment is shown proximal to one side of the modular power source 100. It is to be understood that the wireless power receiver 520 may be provided at any location with respect to the modular power source 100.

The modular power system 300 in the illustrated embodiment provides a plurality of slots 502 arranged in a vertical manner such that the plurality of modular power sources 100 may be stacked. The slots 502 may be configured to support each modular power source 100 and to provide spacing between the plurality of modular power sources 100 so that the weight of each modular power source 100 is supported by the slot 502 rather than a modular power source 100 beneath another modular power source 100. The slots 502 may be configured such that the slots 502 may align the transmitter and receiver pads and also minimize their magnetic gap. The slots 502 may include an integrated thermal management system, such as, the liquid coolant's channel for thermal management of the modular power source 100.

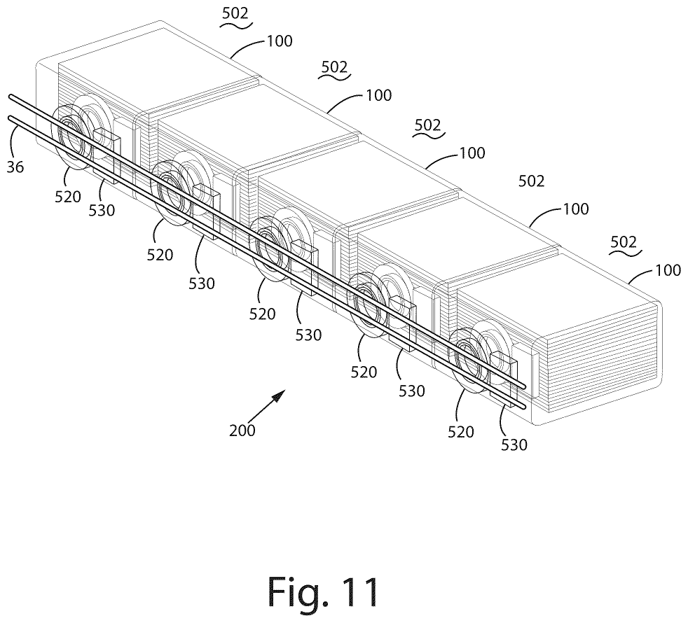

The modular power system 200 in accordance with one embodiment is shown in FIG. 11, including the plurality of modular power sources 100 and slots 502. The modular power system 200 as described herein may provide slots 502 such that the plurality of the modular power sources 100 may be removably installed within the vehicle 10, 20 along a longitudinal axis of the vehicle 10, 20. Similar to the modular power system 300 described in the preceding two paragraphs, each of the plurality of slots of the modular power system 200 may include a wireless power receiver 520 and a rectifier 530, which may be coupled to the vehicle bus 36 for supply or receipt of power by each modular power source 100 relative to the vehicle bus 36.

As can be seen in the illustrated embodiments of FIGS. 10 and 11, the modular power system 200, 300 may include a plurality of wireless power receivers 520, each coupled to a rectifier 530 for converting AC power received by a wireless power receiver 520 into DC power supply to the vehicle bus 36. It is noted that the rectifier 530 maybe operable as an inverter in one or more embodiments described herein, enabling the rectifier 530 to supply AC power to the wireless power receiver 520 and thereby transmitting power from the vehicle bus 36 to the wireless power transmitter 120 of the modular power source 100. The rectifier 530 may include switching circuitry operable as active rectification circuitry or passive rectification circuitry, or a combination thereof. The switching circuitry of the rectifier 530 may be selectively controlled as an inverter, as described herein.

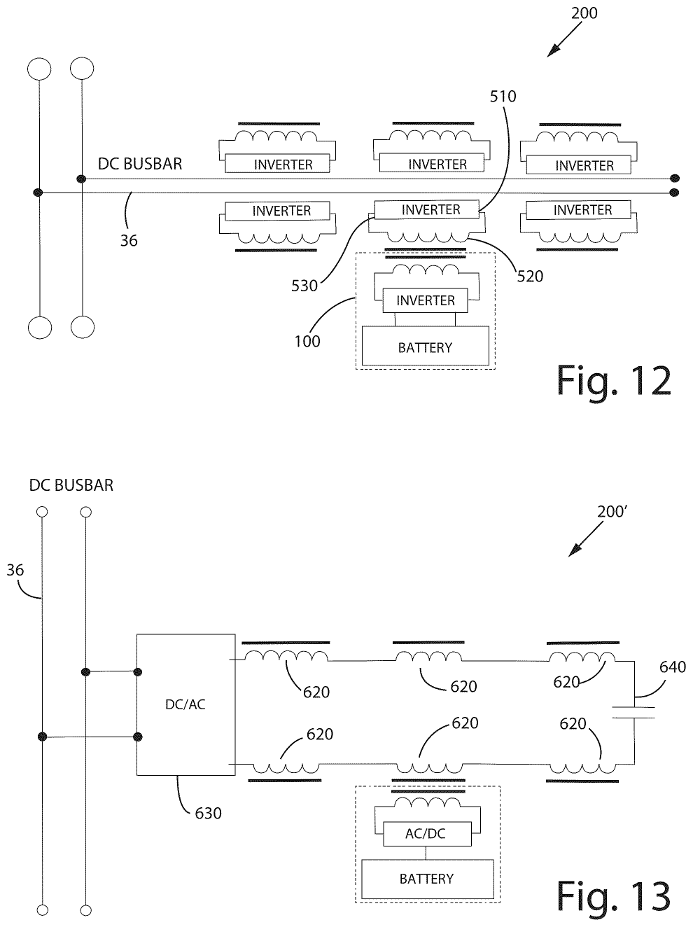

In the illustrated embodiment of FIG. 12, the modular power system 200 is shown in further detail including a modular power source 100 arranged to supply power wirelessly to a wireless power receiver 520. The modular power system 200 includes a plurality of wireless power receivers 520, each coupled to the vehicle bus 36 via a rectifier 530. In the illustrated embodiment, the wireless power receiver 520 and the rectifier 530 may define a wireless input port 510 associated with a slot 502 of the modular power system 200. The modular power system 200 may include a plurality of the wireless input ports 510, each coupled separately to the vehicle bus 36 for supply of DC power to the vehicle bus 36.

The modular power system 200 in the illustrated embodiment may be considered a parallel type wireless configuration, where each modular power source 100 is connected to the vehicle bus 36 via a wireless input port 510 that provides a wireless DC/DC link. The modular power system 200 in accordance with this configuration may avoid any or significant levels of primary compensation circuitry, and provide inductance of different wireless couplers that are independent and do not vary with additional modular power sources 100. Additionally, this configuration may simplify control, because each modular power source 100 is associated with a wireless input port 510 in a one-to-one relationship. It is noted that the current rating of litz wire is sufficient for this configuration; however, the use of multiple inverters and couplers on the vehicle side may be considered a cost concern.

The modular power system in the illustrated embodiment may provide a vehicle bus 36 (e.g., a DC busbar) and a modular power source 100 that are galvanically isolated. In other words, the vehicle bus 36 and the modular power source 100 may have a galvanic insulation-based interface. The modular power system 200 may provide integrated thermal management for both assembly of the modular power sources 100 and the vehicle bus 36. For instance, the modular battery system 200 may be air-cooled or liquid cooled, or both. An air cooled system may include an integrated fan and/or air flow channel, while the liquid cooled system may include a liquid cooling channel. The slot 502 may include an interface for the air/liquid channel from the vehicle to the modular power system, and optionally from the vehicle to one or more of the modular power sources 100.

In an alternative embodiment, shown in FIG. 13, the modular power system is designated 200′ and may be similar to the modular power system 200. The modular power system 200′ may include a plurality of wireless receivers 620 coupled to a rectifier 630, which may be the only rectifier provided for the modular power system 200. The modular power system 200′ in the illustrated embodiment of FIG. 13 may be considered a series wireless configuration, where multiple modular power sources 100 may be coupled to the vehicle bus 36 via a single high frequency AC link. This approach may enable use of fewer components, such as one inverter on the vehicle side. This approach as described herein may involve compensation and frequency control circuitry on the vehicle side. Additionally, the series wireless configuration may involve higher AC cable ratings, to accommodate greater amounts of current relative to the parallel wireless configuration described in conjunction with FIG. 12.

Although the series wireless configuration is described in conjunction with a modular power system 200′ for a vehicle; the series wireless configuration may be adapted for a charging station for supply of power wirelessly from a power source to a plurality of modular power sources 100. The cable ratings for current through the series arranged transmitters and compensation circuitry may be more acceptable for a charging station in order to utilize a single inverter to generate and transmit power wirelessly to the plurality of modular power sources 100.

The plurality of wireless receivers 620 may be arranged in series relative to the rectifier 630 associated with the plurality of wireless receivers 620. In the illustrated embodiment, a compensation circuit 640 (e.g., a capacitor) may be provided in series with the plurality of wireless receivers 620. Each of the plurality of wireless receivers 620 may be associated with a slot, similar to slot 502, of the modular power system 200. The rectifier 630 may convert power received from the plurality of wireless receivers 620 into DC power supplied to the vehicle bus 36.

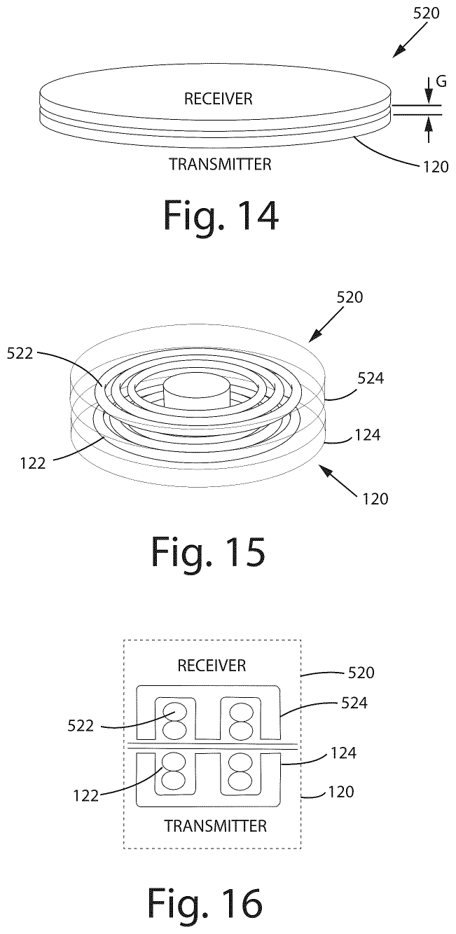

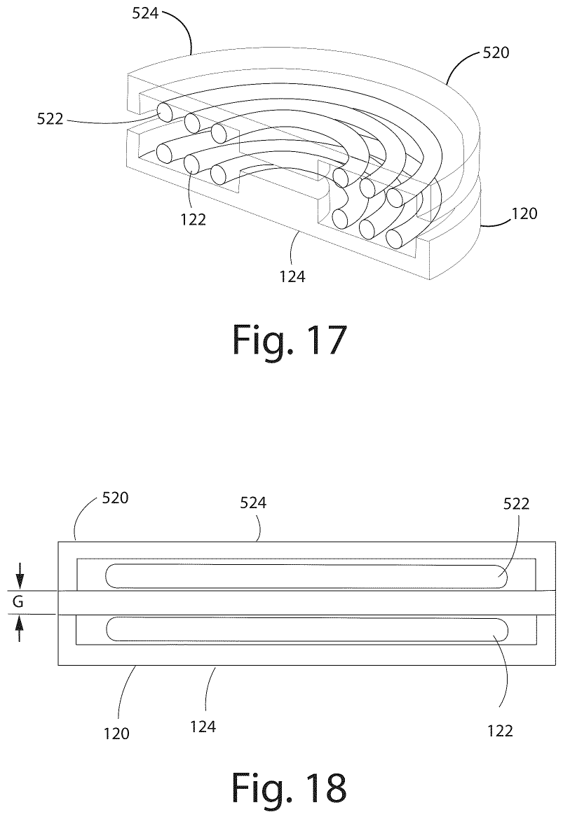

A wireless power transmitter 120 and a wireless power receiver 520 are shown in further detail in FIGS. 14-20. The wireless power transmitter 120 and the wireless power receiver 520 may be configured for transfer of significant power, such as 100 kW. In one embodiment, the diameter of the wireless transmitter and the wireless receiver may be approximately 20 inches, with a thickness of three inches. The weight of the wireless power transmitter 120 and the wireless power receiver 520 may be approximately 10 kilograms.

In use, the wireless power transmitter 120 and the wireless power receiver 520 may be separated by a gap G as shown in FIGS. 14 and 18. The gap G may be between 5 and 10 mm, and may vary depending on the application and positioning of the modular power source 100 within the slot 502. This way, the wireless power transmitter 120 and the wireless power receiver 520 may transfer power despite potential misalignment of the modular power source 100 within the slot 502. It is noted that the wireless power transmitter 120 and the wireless power receiver 520 are shown axially aligned in the illustrated embodiments; however, in use, the wireless power transmitter 120 and the wireless power receiver 520 may be axially misaligned such that a central axis of the wireless power transmitter 120 is not substantially actually aligned with a central axis of the wireless power receiver 520.

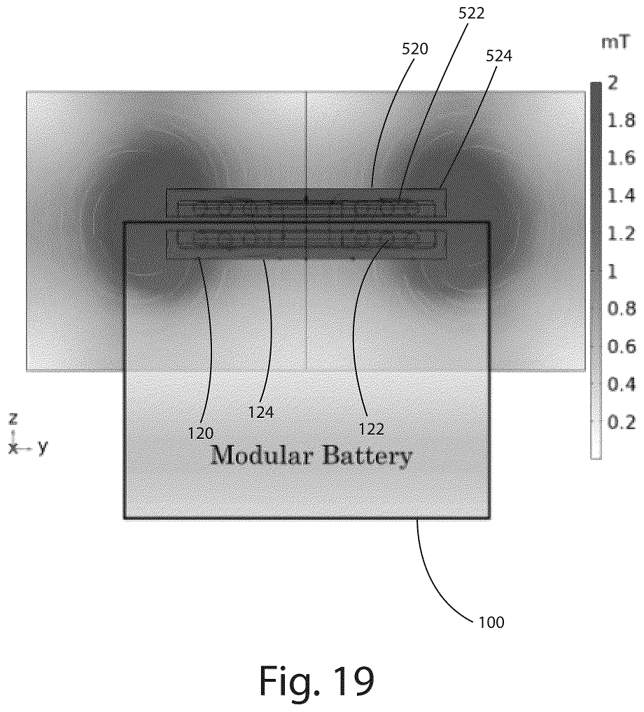

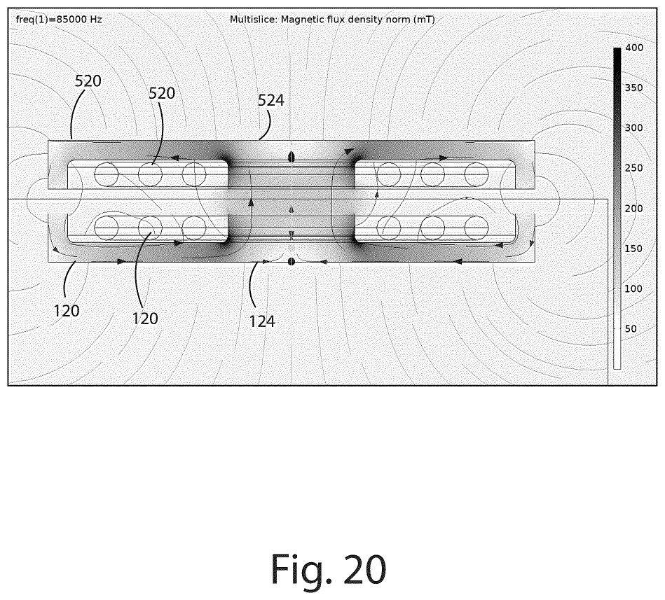

The wireless power transmitter 120 in the illustrated embodiments of FIGS. 15-20 includes a transmitter flux guide 124 and a transmitter coil 122 operable to transmit power wirelessly to the wireless power receiver 520, which may include a receiver flux guide 524 and a receiver coil 522. The transmitter flux guide 124 and the receiver flux guide 524 may be configured in a compact pot-type construction including a recess constructed to receive the respective transmitter coil 122 and the receiver coil 522. The recess of the transmitter flux guide 124 and the receiver flux guide 524 may enable positioning of the transmitter coil 122 and the receiver coil 522 in a manner that enables positioning of guide surfaces proximal to each other to facilitate and focus flux transmission from the wireless power transmitter 120 to the wireless power receiver 520. Flux density and the magnetic field emission are shown in further detail with respect to the flux guide configuration in FIGS. 19 and 20. It is noted that flux density in the region proximal to the transmitter coil 122 and the receiver coil 522 may be 1 mT up to 50 millimeters from the guide surfaces. This level of magnetic field may generate eddy current losses in power packaging and battery packs. The transmitter flux guide 124 and the receiver flux guide 524 may be configured to limit leakage of flux and reduce eddy currents lost in the power electronics packaging and battery packs of the modular power system 200.

Wireless couplers in accordance with one or more embodiments of the present disclosure may generate magnetic field emissions around the wireless power transmitter 120 in the wireless power receiver 520. These magnetic field emissions may be suppressed via configuration of the receiver flux guide 524 and the transmitter flux guide 124. Additionally, or alternatively, a cooling system may be provided to facilitate reduction in losses due to increased heat caused by magnetic field emissions. Further additionally, or alternatively, shielding may be provided to substantially prevent losses potentially resulting from generation of eddy currents.

Circuitry for the modular power source 100 and a wireless input port 510 are shown in further detail in FIGS. 22 and 23. The modular power source 100 and the wireless input port 510 may be configured in a high coupling arrangement, with low current ratings for the coil. Compensation circuitry may be absent. The wireless input port 510 may be utilized in a vehicle 10, 20 or in a charging system, depending on the application. In cases where the wireless input port 510 in the circuitry disclosed in FIGS. 22 and 23 is provided in a charging system, the vehicle bus 36 may be replaced with a DC source, which may include rectification circuitry with respect to AC power received from a grid connection. Additionally in cases where the wireless input port 510 is configured for a charging station, circuitry associated with the wireless input port 510 in the form of a wireless power transmitter may be rated for medium power instead of high-power ratings associated with vehicle use.

The modular power source 100 in the illustrated embodiment includes the battery 110, inverter 130, and the transmitter coil 122. The wireless input port 510 includes the receiver coil 522 and the rectifier 530, which is shown as active rectification circuitry (which is also operable as inverter circuitry for transmission of power from the wireless input port 510 to the modular power source 100). The coupling coefficient for transfer of power wirelessly from the transmitter coil 122 to the receiver coil 522 (or conversely from the receiver coil 522 to the transmitter coil 122) may be between 0.8 and 0.9, potentially 0.85—although the coupling coefficient may be different for different configurations of the wireless power transmitter 120 and the wireless power receiver 520. Coil to coil efficiency may be 99% or greater in one embodiment.

The wireless input port 510 and the modular power source 100 may not utilize compensation circuitry for transfer of power wirelessly from the transmitter coil 122 to the receiver coil 522, or conversely from the receiver coil 522 to the transmitter coil 122. It is to be understood that several configurations described herein are with respect to a vehicle 10, 20 operable to transmit power from the wireless input port 510 to the modular power source 100. Such configurations may be adapted for a charging system separate from other aspects of the vehicle not needed for generating motive power. The charging system, for example, may be coupled to grid power and operable to convert and transmit the power received from the grid for charging the modular power sources 100. The parallel wireless configuration or the series wireless configuration described herein may be adapted for such a charging system, where the wireless receivers, including the wireless input port 510, are adapted for transmitting power instead of receiving power to the wireless power module 100.

The modular power source 100 may include a battery 110, as described herein, such as a lithium-ion battery, that may be operable as a power source for transmitting power wirelessly to the wireless power receiver 520. In an alternative embodiment, the battery 110 may be replaced with another type of power source, which may be an AC or DC power source depending on the application as described herein. In one embodiment, the AC power source in the form of an internal combustion engine (ICE) may be provided in a modular power source 100. Such an ICE-based modular power source 100 may include a fuel reservoir and may operate in conjunction with one or more other modular power sources 100, which may include a battery 110 or other type of power source.

The modular power source 100 in the illustrated embodiment includes a controller 140 operably coupled to drive circuitry 144. The drive circuitry 144 may correspond to pass through conductors that provide a direct connection between the inverter 130 (e.g., switching circuitry, including switches S5, S6, S7, S8) and the controller 140. Alternatively, the drive circuitry 144 may include a multiplexer or signal conditioning circuitry, or both, to translate output from the controller 140 to direct operation of the inverter 130.

The modular power source 100 may optionally include a sensor 142. The sensor 142 may be configured to detect a characteristic of power (e.g., current or voltage, or both) with respect to an aspect of the modular power source 100, such as a voltage of battery 110 or a current through the transmitter coil 122. The sensor 142 may be configured to provide sensor output indicative of the detected characteristic to the controller 140. The sensor 142 is shown separate from the controller 140, but may be integral therewith in one embodiment.

The inverter 130 in the illustrated embodiment includes an H-bridge inverter configuration (e.g., a full bridge) with first, second, third, and fourth switches S5, S6, S7, S8 capable of operating in conjunction with each other to supply power to the transmitter coil 122. The switches S5, S6, S7, S8 may be arranged in an H-bridge configuration with a first leg S5, S6 and a second leg S7, S8.

The inverter 130 may be configured to receive input power from the battery 110, which as described herein, may be any type of power source, including an AC or DC type power source that can be housed within the enclosure 190.

The inverter 130 may translate the input power received from the battery 110 into AC power to be supplied to the transmitter coil 122. The controller 140 may direct operation of the inverter 130 according to a switching frequency to generate the AC power. The switching frequency may be between 3 kHz and 10 MHz, and may optionally be about 85 kHz. In one embodiment, the controller 140 may be operable to vary a switching frequency of the inverter 130. As an example, the controller 140 may obtain sensor feedback from the sensor 142, and adjust the switching frequency based on the sensor feedback.

In an alternative embodiment, the inverter 130 may be provided in a half bridge configuration with first and second switches operable to provide power to the transmitter coil 122. The drive circuitry in this alternative embodiment may be different from the drive circuitry 144 in order to drive first and second switches instead of four switches.

The switches S5, S6, S7, S8 may be IGBTs or any other type of switch capable of selectively supplying power to the transmitter coil 122, including for example MOSFETs.

Although the inverter 130 is described in conjunction with several embodiments as being operable to energize the transmitter coil 122 for transfer of wireless power to the wireless input port 510, it is to be understood that the inverter 130 may be also operable as rectification circuitry (e.g., active or passive rectification) for receipt of wireless power, such as from the vehicle 10, 20 or a charging station for the modular power source 100.

In the illustrated embodiment, the modular power source 100 may include power conditioning circuitry capable of conditioning the power received from the battery 110. The power conditioning circuitry may correspond to a pass-through configuration between the battery 110 and the inverter 130. Alternatively, the power conditioning circuitry may correspond to rectification circuitry operable to rectify AC power received from an AC power source into DC power as the input power provided to the inverter 130. Additionally, or alternatively, the power conditioning circuitry may include filter or compensation circuitry, such as a choke.

The controller 140 may be coupled to one or more components of the modular power source 100 to achieve operation in accordance with the described functionality and methodology.

The controller 140 may include electrical circuitry and components to carry out the functions and algorithms described herein. Generally speaking, the controller 140 may include one or more microcontrollers, microprocessors, and/or other programmable electronics that are programmed to carry out the functions described herein. The controller 140 may additionally or alternatively include other electronic components that are programmed to carry out the functions described herein, or that support the microcontrollers, microprocessors, and/or other electronics. The other electronic components include, but are not limited to, one or more field programmable gate arrays (FPGAs), systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in other manners, whether combined into a single unit or distributed across multiple units. Such components may be physically distributed in different positions in the system or aspects thereof, or they may reside in a common location within the system or an aspect thereof. When physically distributed, the components may communicate using any suitable serial or parallel communication protocol, such as, but not limited to, CAN, LIN, Vehicle Area Network (VAN), FireWire, I2C, RS-232, RS-485, and Universal Serial Bus (USB).

The wireless input port 510 in the illustrated embodiment is coupled to the vehicle bus 36, which is operable to use power received wirelessly from the modular power source 100 or to transmit power wirelessly to the modular power source 100. For instance, the wireless power receiver 520 may be coupled to the vehicle bus 36 to provide power thereto via the rectifier 530. The rectifier 530 may be operable as active or passive rectification circuitry configured to rectify power received wirelessly from the modular power source 100 for delivery of the received power to the vehicle bus 36.

In the illustrated embodiment, the wireless input port 510 includes a controller 540 and drive circuitry 542, similar to the controller 140 and drive circuitry 144 described in conjunction with the modular power source 100. Similar to the modular power source 100, the wireless input port 510 may optionally include a sensor 544, which may provide sensor output to the controller 540. Such sensor output may be used by the controller 540 as a basis for adjusting operation of the rectifier 530.

The rectifier 530 may include a plurality of switches S1, S2, S3, S4 arranged similar to the switches S5, S6, S7, S8 described in conjunction with the inverter 130. For instance, the switches S1, S2, S3, S4 may be arranged in an H-bridge configuration with a first leg S1, S2 and a second leg S3, S4.

The controller 540 of the wireless input port 510 may be configured to direct operation of the rectifier 530 to drive the receiver coil 522 with an AC signal to transmit power wirelessly, instead of receiving power wirelessly, to the transmitter coil 122 of the modular power source 100. The controller 540 may direct such operation in a manner similar to the controller 140 of the modular power source 100, such as by controlling operation of the rectifier 530 according to a switching frequency in order to operate as an inverter.

An equivalent circuit construction of the wireless receiver and wireless transmitter configuration in accordance with one embodiment is shown in FIG. 23. The coupling factor for the wireless receiver and wireless transmitter (e.g., the wireless power transmitter 120 and the wireless power receiver 520) may be high as described herein, such as 0.9 compared to 0.3 to 0.54 conventional large air gap wireless power transfer systems. Because the coupling factor is high, in one embodiment, compensation circuitry may not be utilized. However, it is noted that compensation circuitry may be utilized in some circumstances, such as to enhance system performance. For instance, enhancement of system performance may relate to zero voltage switching (ZVS) operation of the inverter.

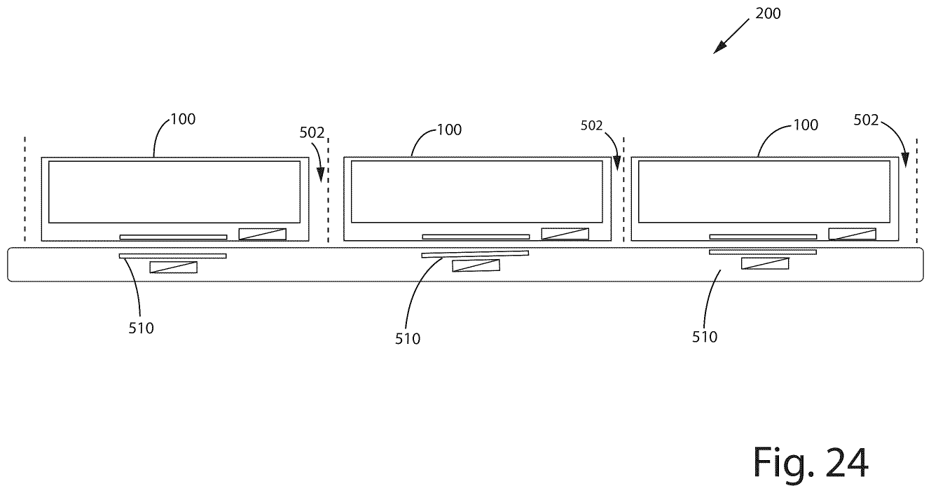

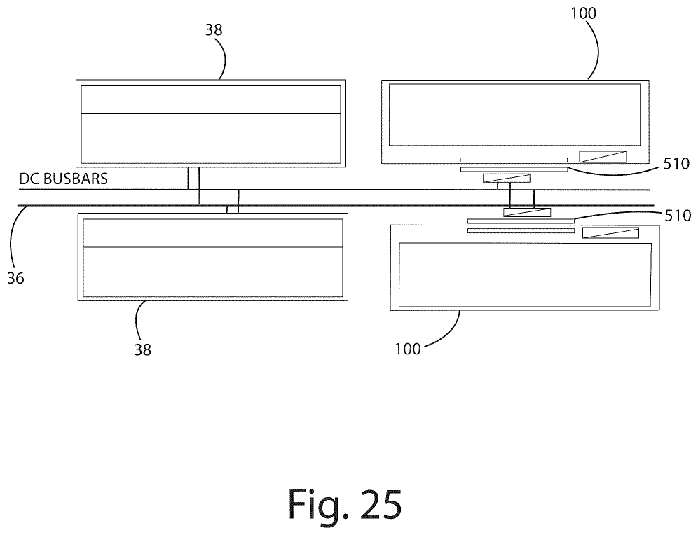

The modular power system 200 in accordance with one embodiment of the present disclosure is shown in FIGS. 24 and 25. The modular power system 200 includes a plurality of slots 502 operable to removably receive a modular power source 100. A wireless input port 510 is provided for each slot 502. The wireless input port 510 may include a wireless power receiver 520 and a rectifier 530. Alternatively, the rectifier 530 may be absent from the wireless input port 510. In this configuration, a rectifier 530 may be provided that is shared by more than one wireless input port 510. The wireless power coupling between the modular power source 100 and each wireless input port 510 of the modular power system may provide galvanic isolation between the wireless input port 510 and the modular power source 100.

As can be seen in the illustrated embodiment of FIG. 25, the modular power system 200 may couple each of the wireless input ports 510 to the vehicle bus 36. The vehicle bus 36 may also accommodate other types of power sources, such as an onboard battery 38. This way, the modular power system 200 may be adaptable for use with a variety of vehicle configurations. The modular power system 200 in one embodiment may provide a modular power source 100 that can be inductively coupled to the vehicle bus 36 through a wireless coupler utilizing high frequency inverter configurations. The power level of the couplers and the inverters may depend on the capacity of the battery 110 of the modular power source 100 and target or maximum charging or discharging rates. The modular power source 100 may charge an onboard battery 38 of the vehicle 10, 20 or direct feed the traction inverter 32 of the vehicle 10, 20.

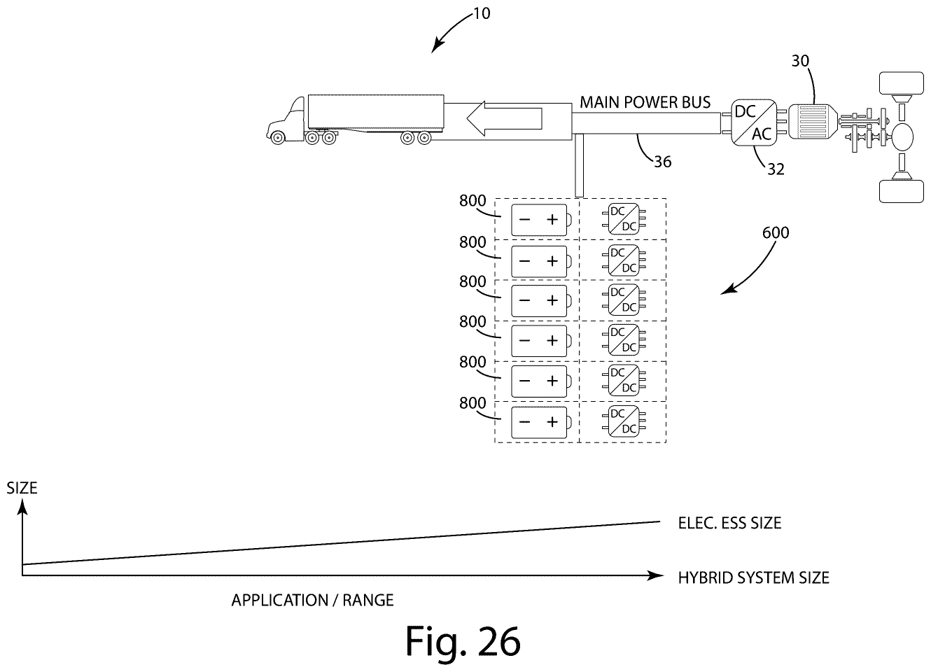

A vehicle 10 in accordance with an alternative embodiment is shown in FIG. 26 along with a modular power system 600, which is similar to the modular power system 200 with several exceptions. The vehicle 10 in the illustrated embodiment includes a traction inverter 32, an electric motor 30, and a main power bus 36, which may be configured in a manner similar to the same components described in conjunction with the vehicle 10 in the illustrated embodiment of FIG. 1. The modular power system 600 may be coupled to the main power bus 36 and may include a plurality of slots adapted to receive one or more modular power sources 800. The one or more modular power sources 800 may be similar in some configurations to the modular power source 100, with several exceptions as described herein, including power management capabilities. One or more of the modular power sources 800 may be configured for supply of power wirelessly with respect to a slot of the modular power system 600. Likewise, a corresponding slot of the modular power system 600 may be configured for receipt of wireless power. One or more of the modular power sources 800 may be configured for supply of power via direct electrical contacts with corresponding electrical contacts of a slot provided by the modular power system 600.

The modular power source 800, like the modular power source 100, make take many forms, including a battery-based configuration, a fuel cell, and an ICE-based generator (e.g., gasoline, diesel, and/or propane). In cases where a fuel cell or ICE-based generator is utilized, a fuel source 801 may be provided in a slot of the modular power system 600. Alternatively, the fuel source 801 may be integral to the modular power source 800, another area of the modular power system 600, or an area of the vehicle 10 separate from the modular power system 600.

Similar to the modular power source 100, the modular power source 800 may be removably placed within a slot and operable to transfer power to the vehicle 10. The modular power source 800 may be placed within the slot for transfer of power to aspects of the vehicle 10, and may be removed from the vehicle 10 for charging purposes at a charging station. The process of removing or installing (or both) the modular power source 800 may be conducted in an automated manner without human intervention. Alternatively, a human operator may facilitate removal or installation, or both, of the modular power source 800 in the vehicle 10.

As described herein, the modular power system 600 may include any configuration of modular power sources 800, including multiple modular power sources 800 of the same type or multiple modular power sources 800 of different types. The configuration of the modular power system 600 may vary based on the use case of the vehicle 10, such as a target range.

The modular power system 600 in one embodiment may be described as an on-board electrical energy storage system (EESS). The modular power system 600 may be reconfigurable in a manner that is readily adapted to customer use cases to support mission diversity, with positive economics. The modular power system 600 may be configured to support rapid, durable, and safe module replacement, allowing end-customers to “right size” and “right chemistry” the mission storage needs in the field. A given vehicle class may experience several different applications or use-cases with a broad span of required range, energy, and carbon footprint. Battery energy use and availability may affect capital expenditure, payload, range, energy efficiency, and fuel costs.

For example, Class 8 tractors-trailers use-cases may cover drayage through line haul, e.g., with diversity in trailer/cargo profiles. A single vehicle may even have regular variations in its use-cases, e.g., shift 1 vs. shift 2 differences. A modular power system 600 cording to one embodiment may enable users to add/subtract energy storage modules to/from each vehicle 10 as suitable for an upcoming mission. This provides an affordable solution for increased mission flexibility in a commercial vehicle fleet.

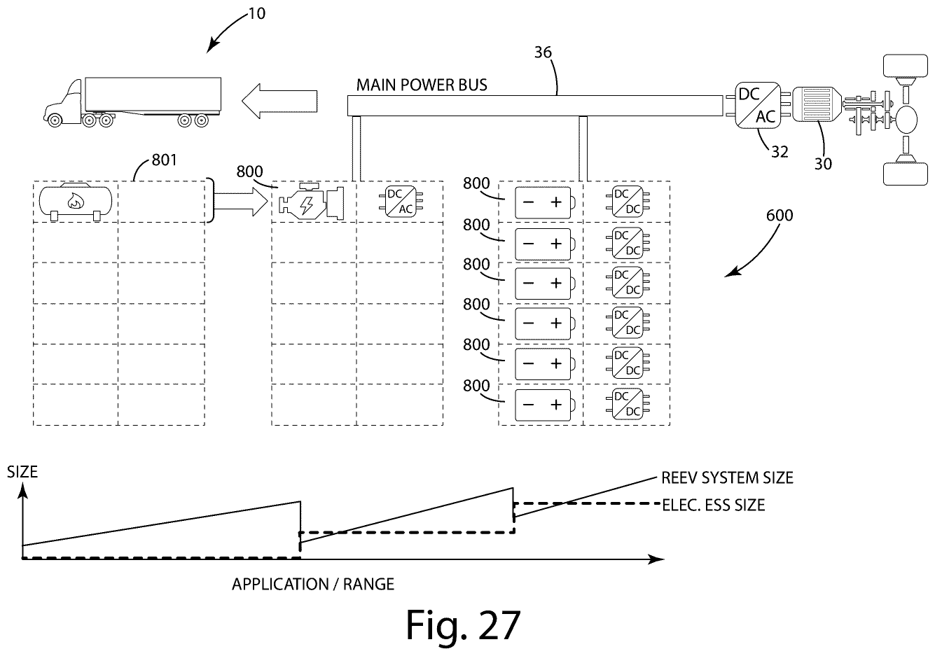

The modular power supply system 600 may be configured for reconfiguration or “resizing” by the end-customer for mission tailoring to increase powertrain flexibility. In this manner, the same near-ZEV/ZEV (zero-emission vehicle) can be used for a multitude of applications while not burdening the powertrain with a fixed solution designed for a worst-case scenario. As shown in FIGS. 26-28, a battery electric vehicle (BEV)/hybrid electric vehicle (HEV)/range extended electric vehicle (REEV)/fuel cell electric vehicle (FCEV) architecture may be “right sized” based on application demand, e.g., mission energy, carbon footprint, or capability, by simply adding or subtracting modular power modules 800.

As shown in FIG. 26, the BEV architecture may be scaled based on application demand, e.g., mission energy, by simply adding or subtracting modular power modules 800. Likewise, the same may be achieved with a HEV, REEV or an FCEV architecture. FIGS. 26-28 shows sizing that occurs based on the building blocks available, and as a function of the energy/carbon footprint/capability demand.

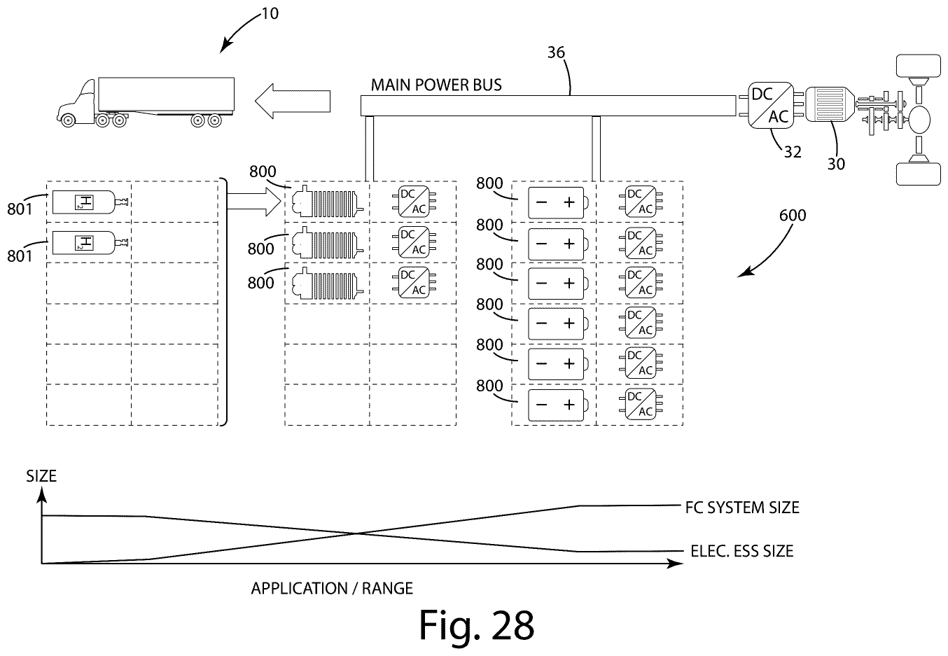

As an example, as shown in FIG. 28, an FCEV may be sized with a FC for charge sustained line haul. However, the customer may choose to use it periodically for shorter haul missions which may be more effectively covered using a BEV powertrain. By upsizing the battery through additional modules 800, those shorter ranges may now be covered in BEV mode. This adaptability may overcome issues associated with high-cost hydrogen, limited FC transients, e.g., life implications, etc. The same vehicle employed for line haul transport may now downsize the battery by removing power module 800, and operate as a charge sustaining FCEV with a fuel cell-based power module 800. This approach may address weight challenges associated with BEV line haul applications.

Flexibility of the modular power system 600 may further extend to different chemistries of the battery-based modular power source 800. As described above, each architecture and user choice of charging solution may influence the recommended choice of cell chemistries. The modular power source 800 may have specific attributes and functions that differ based on the powertrain architecture. Based on customer value propositions, such as total cost of ownership (TCO), weight and packaging constraints may emerge. An REEV with a short EV range, e.g., mid-size power system 600, may utilize mid-power capability cell chemistry to support appropriate charging and regeneration pathways. A REEV with a large EV range, e.g., large-size power system 600, may utilize a high-energy capability akin to a BEV. A BEV with one-charge per day or per mission, e.g., very large-size power system 600, may require a high-energy capability cell chemistry. A BEV with fast-frequent recharges, e.g., large-size power system 600, may utilize a high-power/mid-energy cell chemistry. An FCEV with charge sustaining, e.g., small power system 600, may utilize a high-power cell chemistry.

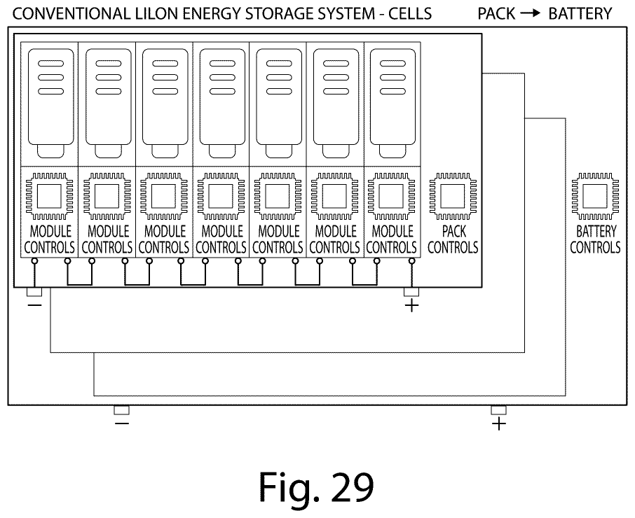

A conventional battery for a vehicle is shown in the illustrated embodiment of FIG. 29 for purposes of discussion. The conventional battery includes a plurality of battery cells that together form a pack, with multiple packs forming the vehicle battery. In this configuration, the cells have the same chemistry, aging is considered uniform for all cells, and cells are configured for a target energy and voltage level through a blend of cells in series and parallel. The blend of battery cells (e.g., the cell architecture of packs) is set by the original equipment manufacturer (OEM), and replacement or maintenance of the vehicle battery of this conventional type is often done at a service center or site licensed to do so by the OEM.

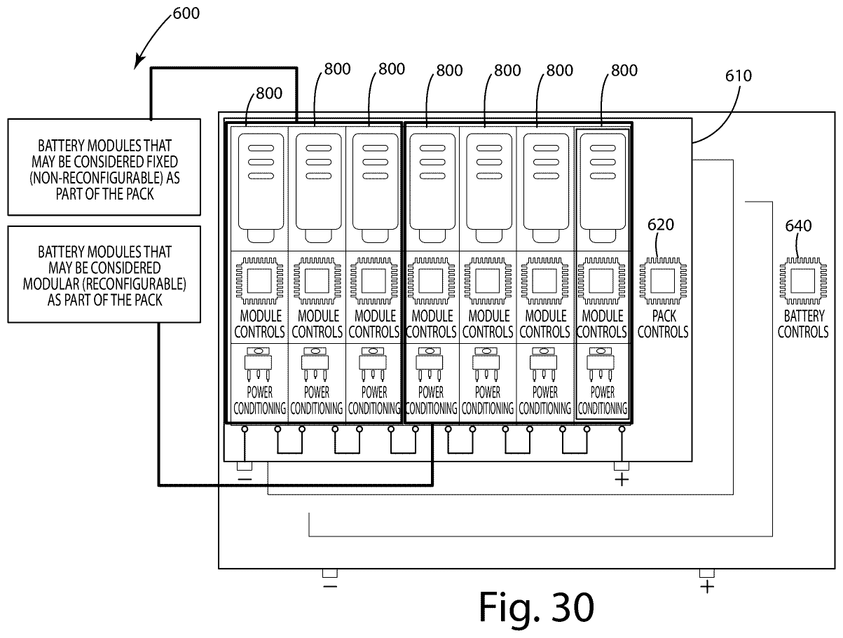

A modular power system 600 according to one embodiment is shown in FIG. 30. The modular power system includes a plurality of modules 800. The modules 800 may be arranged in one or more packs 610 to form a power supply for the vehicle 10. In some configurations, the modules 800 may be considered fixed or non-reconfigurable as part of a pack 610, and other modules 800 may be modular or reconfigurable as part of the pack 610. The pack 610 may include a pack controller 620 operable to direct power with respect to the modules 800 that form the pack 610 associated with the pack controller 620. Each pack 610 may include such a pack controller 620. The modular power system 600 may include a power controller 640 operable to direct power with respect to the packs 610 of the modular power system 600. The configuration of the packs 610 of the modular power system 600 may be adapted at the vehicle and/or by a customer.

In one embodiment, one or more of the modules 800 may include a common format but may have a different chemistry and age/degradation. In this way, the modules 800 may not be common across modules 800 or packs 610 e.g., mixing Li-ion with ultracapacitors. The number of modules 800 or packs 610 may vary, and as described herein, may utilize power conditioning to satisfy main power bus requirements. The modules 800 may be configured for a target energy and voltage level through a blend of cells in series and parallel, e.g., akin to conventional but with target value considerations specific to a particular use case for the vehicle (e.g., long or short haul). Series and/or parallel interconnects of modules 800 and packs 610 may differ from a conventional approach in which the interconnects are fixed. The base (aka common) architecture elements may be configured at the OEM level, but replacements of modules 800 can be performed by end-user fleet depots.

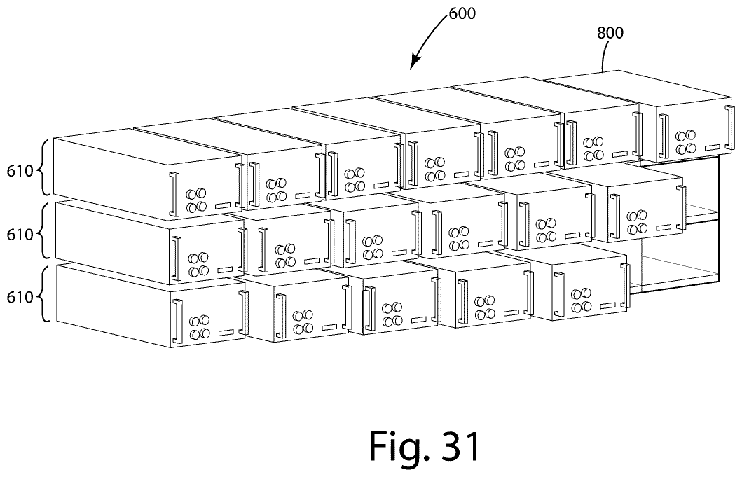

The modular power system 600 according to one embodiment may provide a variable count, e.g., size, age and chemistry of each module 800 and each pack 610. FIG. 31 shows an example embodiment with such variations among packs 610. As can be seen, the number of modules 800 in one pack 610 may be different from the number of modules in another pack 610. A customer may choose a different number of modules 800 to insert based on a mission length. The module is 800 provided in a pack may have different state of health and/or life characteristics. Additionally, the modules 800 inserted may have different chemistry characteristics. The modules 800 maybe configured for rapid, durable, and cost effective removal and insertion from a pack 610. The modular power system 600 in one embodiment may include multiple bays for multiple packs (e.g., one bay may accept or receive a pack 610, which may include one or more modules 800).

With variable arrangements of modular power sources 800, the modular power system 600 may be configurable to have a different total capacity, e.g., number of modules in a pack may be changed out, based on the specific mission that the vehicle 10 needs to perform.

The chemistry of the modular power system 600 may be changed out to better match the needs of the other elements that produce power, e.g., FCEV may utilize more of a power chemistry, but BEV may utilize more of an energy chemistry. Chemistry may include ultracapacitors in addition to batteries.

The modular power system 600 may be configured by the end-user to meet range, life, weight, and c-rate constraints—an example of this configuration analysis is shown in the table below:

1st order Battery sizing is based on:

| | | 1 C RMS Mission | Total Throughput |
|---|---|---|---|
| | EV Mission Need | Power Constraint | Capacity for 5 years |
| REEV/BEV: | B_{size} + E_{kWh/hr} * | B_{size} + P_{pwr RMS}/ | B_{size} = T_{kWh/hr} * |
| Max of → | H_{hr/mission} | C_{Tgt C-Rate} | H_{hr/mission} * |
| HEV/FCEV: | | | M_{missions/yr} * Y_{years} ÷ |
| Max of → | | | N_{100% ΔSOC cycles} |
| Example: | B_{size} = 35 kWh/hr * | B_{size} = 125 kW/ | B_{size} = 40 kWh/hr * |
| | 10 hr = 350 kWh | 1 C = 125 kWh | 10 hr * 250 days/yr * |
| | | | 5 yr ÷ 6000 = 83 kWh |

May want to consider throughput capacity at EoL of 70%

Each module 800 in one embodiment may have its own high voltage interlock loop (HVIL) to protect insertion and removal processes.

Each module 800 in one embodiment may have a primary switch to indicate status to a controller (e.g., the pack controller 620 or the power system controller 640) that it is seated correctly and available to produce power for the power system 600 (e.g., the overall battery or energy storage pack).

Energizing of each module 800 may have a dedicated pre-charge circuit with each module 800 and with the system 600. These may provide a collective fault out if any one of the modules 800 has a fault.

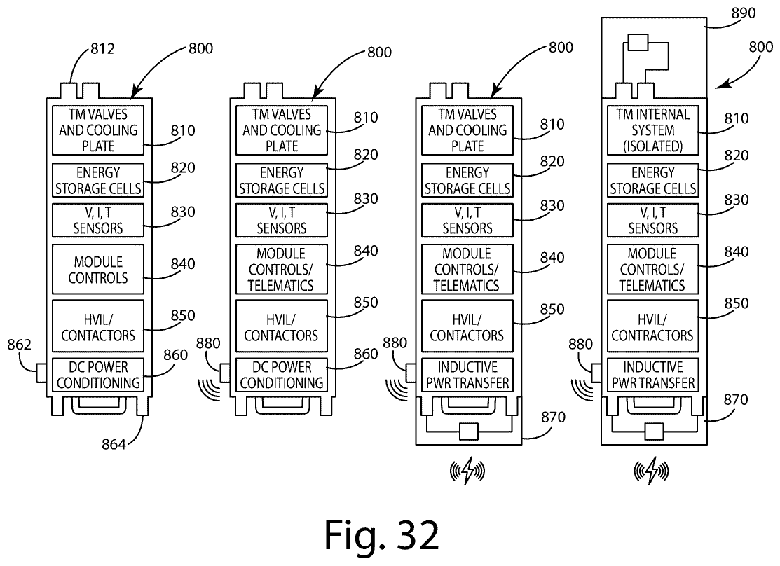

The modular power system 600 in one embodiment may include one or more power conditioning systems 860. More specifically, one or more modules 800 may include a power conditioning system 860 operable to regulate power transfer to or from the module 800. Such a power conditioning system 860 is shown in conjunction with several modules 800 configured according to various embodiments of the disclosure. It is noted that two of the modules depicted in FIG. 32 are configured for wireless power transfer and include an inductive power transfer system 880. This inductive power transfer system 880 may incorporate aspects of the power conditioning system 860 described herein.

The modules 800 in the illustrated embodiment include several components in common, including energy storage 820, a sensor system 830 (e.g., voltage, current, temperature sensors, and light combination thereof), a module controller 840, and switching circuitry 850 (e.g., high voltage contactors). The modules 800 may also include a temperature management system 810, which may interface with an external system via a external temperature system connection 812 (e.g., an external coolant connection) or operate in conjunction with an internal or integral temperature system 890. The modules 800 in one embodiment may include a low voltage connection 862 and a high voltage connection 864. Additionally, or alternatively, the modules 800 may an inductive power transfer system 870 for wireless power transfer to or from the module 800.

The inductive power transfer system 870 may be configured similar to the wireless power transfer system described herein and conjunction with the module 100. For instance, the inductive power transfer system 870 may be configured to transfer power from module 800 to the main power bus 36, or alternatively to receive power from the main power bus 36.

In one embodiment, the modules 800 may include a wireless communication system 880, which may be configured to communicate wirelessly with one or more systems external to the modules 800.

In one embodiment, power transfer from/to each module 800 in a multi-type configuration (e.g., modules 800 of different types) may be a function of the limits of each module 800 that may vary significantly across a pack 610. The power conditioning system 860 may control power transfer to and/or from the module 800 in order to maintain module and system integrity.

In order to mix modules of different chemistries and ages, the system 600 may utilize control aspects that can detect the capabilities of available modules 800 and the requirements of the main vehicle bus 36 and adjust the module power profile to support this system.

This system 600 can be implemented in either a wireless power transfer (WPT) system or wired power transfer system, as shown with the modules 800 in FIG. 32 being configured for wired power transfer or wireless power transfer. However, the physical implementation for wired and wireless power transfer systems may be different. As a result, at the hardware level for a wired system, the power conditioning system 860 (e.g., a power electronic component) can be a current limited voltage regulator. Specific controls and onboard sensing/communication elements may be utilized in conjunction with the power conditioning system 860 to provide system operational behavior.

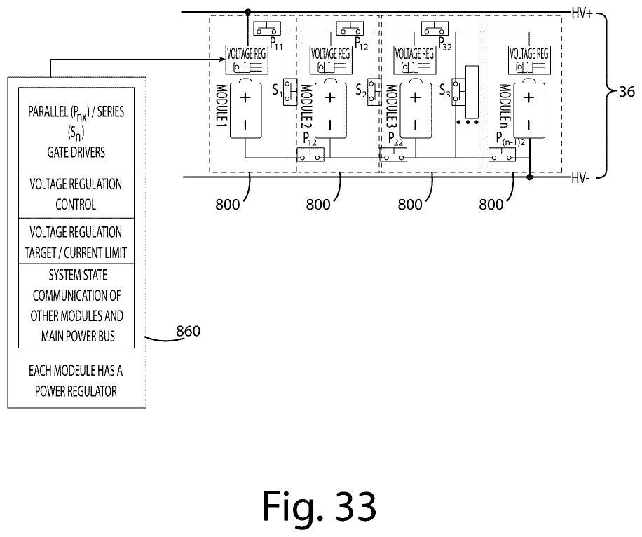

A power conditioning system 860 according to one embodiment is depicted in FIG. 33. As can be seen, the power conditioning system 860 may be configured to communicate with one or more external systems, such as one or more other modules 800 on the main power bus 36. The power conditioning system 860 may determine an operational mode based on information received to view communications with one or more the external systems. The power conditioning system 860 may be configured to receive communication on main bus voltage requirements, and to receive information on a configuration of the modular power system 600 and/or the pack 610, such as whether one or more modules 800 are configured in parallel or series. For instance, if parallel, the power conditioning system 860 may set target voltage regulator levels to meet the voltage targets of the main bus 36, and set current limits based on power limits of the module 800, e.g., I=P/Vₛₑₜₚₒᵢₙₜ. As another example, if series, the power conditioning system 860 may identify the number and voltage capability of each of the other modules 800 in series with the module 800. Using the sum of voltages, the power conditioning system 860 may determine a voltage regulator level to meet the voltage targets of the main bus 36 and set current limits based on the power limits of the specific module 800, e.g., Vₛₑₜₚₒᵢₙₜ=V_{target}−ΣV_{modules}, and I=P/Vₛₑₜₚₒᵢₙₜ.

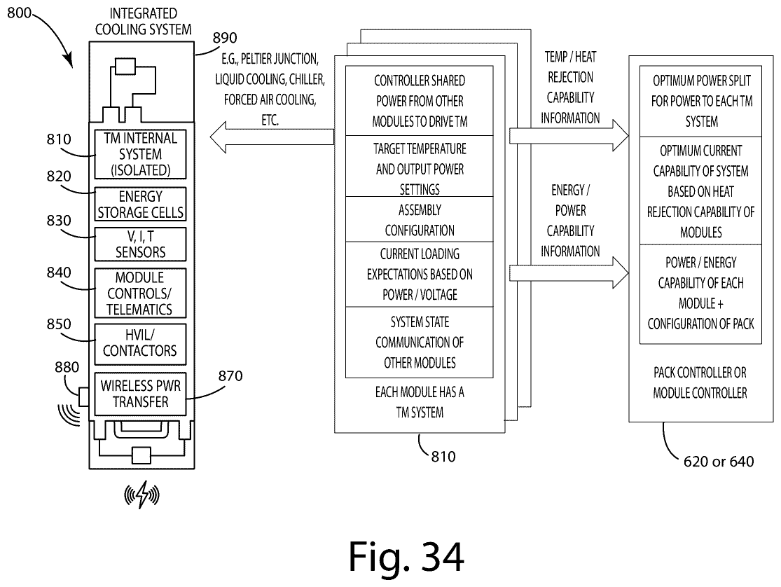

A temperature management system 810 according to one embodiment is depicted in FIG. 34. To configure the modular power system 600 as a flexible platform, the temperature management system 810 provided in conjunction with the module 800 may be configured as an isolated intelligent TM approach, such that each module 800 has its own temperature management system 810. To mix modules of different chemistries and ages, temperature management system 810 may operable to detect the capabilities of the available modules 800 and the requirements of the individual module 800 that it manages, and then adjust the module cooling system temperature profile to support the modular power system 600. The temperature management system 810 can be used in either a wireless or wired power transfer system, and in either series or parallel electric voltage/power configuration. The temperature management system 810 can be configured to adequately dissipate the heat generated by each module 800 during charging or discharging, while achieving a specific target temperature that can be dependent on each individual module 800, e.g., such that temperatures may be different from one module 800 to another module 800, or from one chemistry/degradation factor to another.

The temperature management system 810 in one embodiment may be configured to convert heat energy into electrical energy (e.g., thermal recuperation) to provide power to the modular power system 600. This power may be utilized by the modular power system 600 for motive power and/or charging one or more modules 800.

Control over temperature and heat rejection may also be provided by the temperature management system 810. For instance, a temperature management system 810 (which may be isolated and enclosed) within a module 800 can be performance impacted based on how it is configured in the larger pack assembly. A system identification process implemented by the temperature management system 800 may assess the system, by itself in conjunction with other temperature management systems 800 and/or controllers of the modular power system 600, capabilities dynamically and compensate the current draw limits based on this identification. The temperature management system 810 may be configured to provide a pathway to share electrical energy to drive critical components between each of the modules 800, so that the pack 610 can be optimally or beneficially governed to both maintain individual module heat rejection/temperature targets and maximize or enhance the energy efficiency or degradation factor of the pack.

The temperature management system 800 may provide an intelligent cooling system for each module 800. In one embodiment, the temperature management system 800 may provide a dedicated cooling system that utilizes knowledge of assembly of each module 800 to determine the achievable temperature setpoints and power limits. In one embodiment, the cooling system electrical power may be borrowed from other modules 800.

Operation of the temperature management system 800 in accordance with one embodiment is depicted in FIG. 34. The temperature management system 800 may interface with the pack 610 as well as the pack controller 620 and/or the module controllers 640 to receive information of the various states of the modules 800 and the pack 610, including configuration, e.g., series or parallel.

The pack controller 620 and/or the module controller 640 may be operable to determine pack level optimization or enhanced operation by detecting capabilities of each module 800 in the pack 610 and the configuration of each module 800 in the pack 610, e.g., series or parallel electric circuit. Using this information, the maximum current capability may be determined for the pack 610 based on the ability to achieve target heat rejection requirements.

Next, the pack controller 620 and/or the module controller 640 may determine the enhanced or optimal power draw from each module 800 to drive all the electronic components of temperature management system 810, e.g., pumps, sensors, circuits, etc., to achieve the target heat rejection. The enhanced or optimal power draw may achieve the target power requirements while enhancing or maximizing the efficiency. For example, a module 800 configured for high energy capacity may be better suited to send power to other modules 800 for their temperature management systems 810 than powering those temperature management systems 810 through the energy capabilities of each individual pack 610. This mode of operation may be adjusted dynamically as the state of charge, health, and power (SOC, SOH, SOP) of each module 800 changes during a mission.

Each module 800 may be configured to achieve a target temperature and heat rejection by powering its temperature management system 810 using power from the allocated resource. Actual versus target information can be shared back with the pack controller 620 and/or the module controller 640 that may conduct an optimization or enhancement process that may change the targets and allocations.

Additionally, each module 800 may be configured to determine its capabilities on current draw limits based on achievable heat rejection and system temperatures. These may also induce derates as considered necessary to protect the system 600 and to manage thermal runaway events.

Thermal runaway events, or other emergency events can be treated with a separate process that gains priority over all other requirements in the system 600 and can be allowed to achieve maximum or enhanced cooling power from the temperature management system 810.

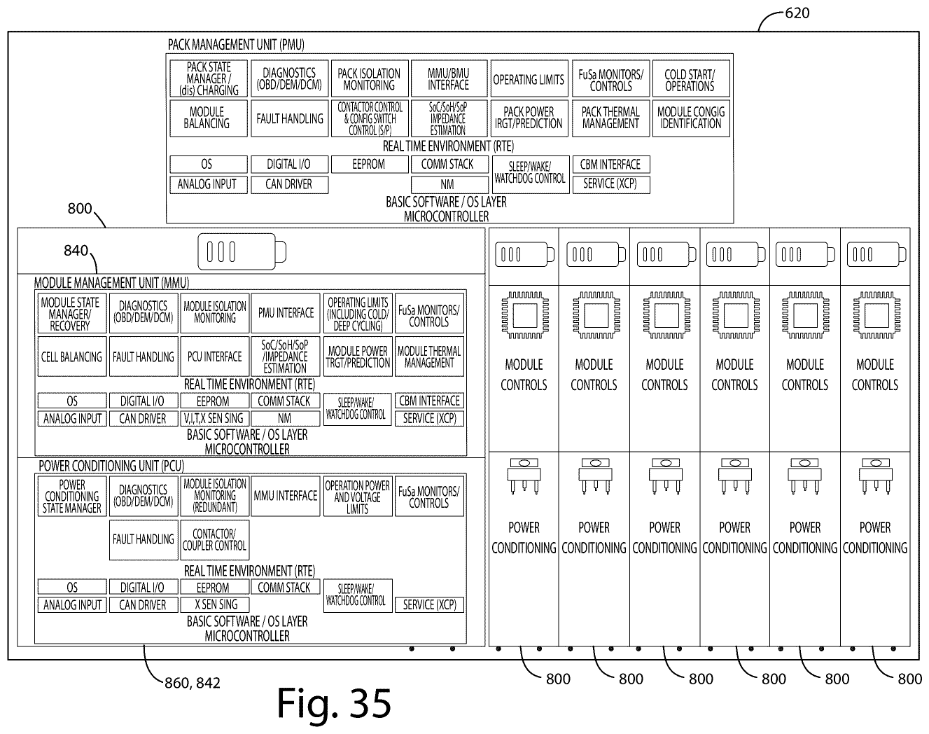

Turning to the illustrated embodiment of FIG. 35, a modular power system 600 is shown including a plurality of modules 800 and a pack controller 620.

Each module 800 may include a module controller 840 and a power conditioning system 860 with a power conditioning unit 842. In one embodiment, multiple modules 800 together form a pack 610 that can be controlled with a pack controller 620 (e.g., a pack management unit (PMU)). And multiple packs 610 are controlled with a system controller 640 (e.g., a battery management unit (BMU)). The system controller 640 may include functions similar to the pack controller 620, and therefore the pack controller 620 may be generalized to function as a system controller 640 as well. The system controller 640, in one embodiment, may include the pack controller 620. The system controller 640 and its capabilities and functions may enable both wireless and/or wired power transfer.

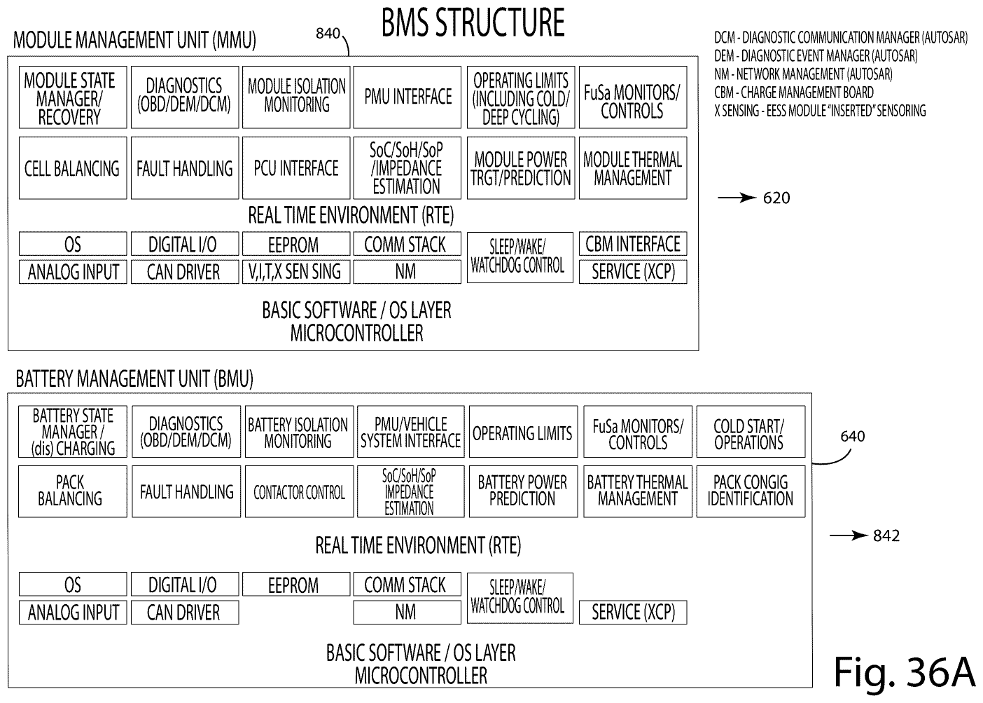

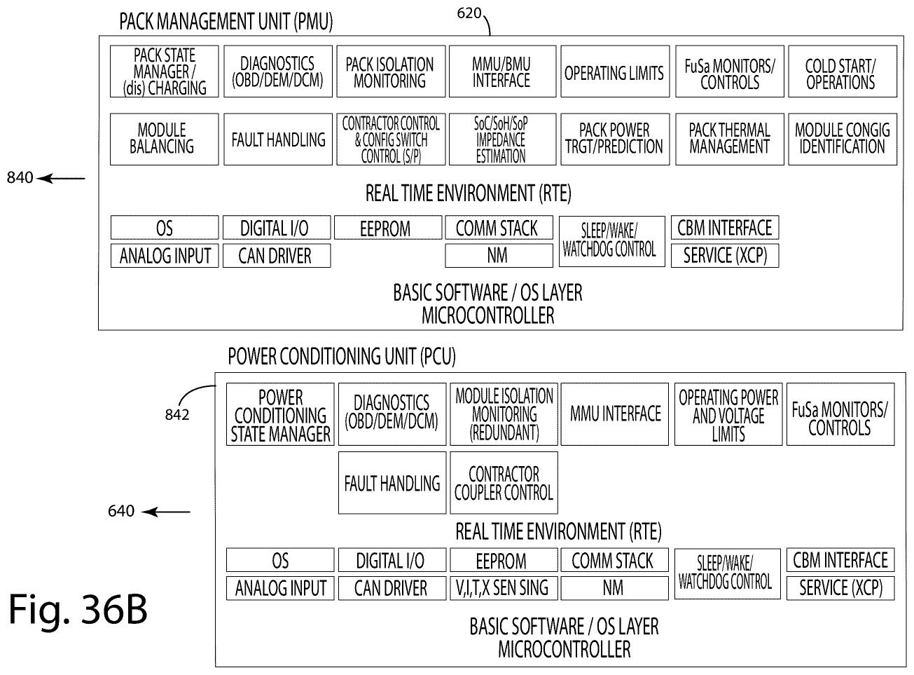

A control architecture of the system 600 is shown in FIGS. 35-37. The architecture and operational modes for the module 800 and pack 610 are depicted. As depicted, common functionality is provided to address identification and controllability of additional/subtracted modules 800. The system 600 may be augmented with the power conditioning system 860 and temperature management system 810. Additionally, or alternatively, the system may be configured to conduct measurements and/or analysis related to state of health (SOH) and state of charge (SOC) for a mixed chemistry and mixed health (degradation).

The module controller 840 and the pack controller 620 may provide thermal management functionality that is configured to manage operation of each module 800, e.g., based on unique chemistry, age/degradation factor, and capacity. This operational mode may facilitate identifying/establishing and maintaining the power/current draw levels from each module 800 to meet requirements or target operational modes of the pack 610 and the system 600.

In addition, the pack controller 620 may be configured to provide a pathway to control the power interface, e.g., voltage levels and current limits, of each module 800 with a pack main power bus (e.g, the shared bus of multiple modules 800 in the pack 610) and the vehicle main power bus 36. As each module 800 is pulled out (e.g., subtracted) and a new one is inserted (e.g., added), the total number of modules 800 and their capabilities (e.g., chemistry, etc.) can change. The pack controller 620 may be configured to maintain a common main vehicle bus voltage 36 through individual module voltage regulation. The pack controller 620 may be configured to also support the nature of parallel or series connections of the modules 800 with the pack 610. In one embodiment, the system controller 640 may arbitrate the settings for the pack controller 620 or functions thereof. Thus, the pack controller 620 may be configured to determine if the modules 800 need to be in a series or parallel configuration based on main bus voltage 36 needed and voltage and current limit levels available for each of the available modules 800.

The pack controller 620 and/or the system controller 640 may provide methods for describing the SOH/SOC/SOP of the overall pack 610 based on the individual SOH/SOC/SOP of each module 800 as described herein.

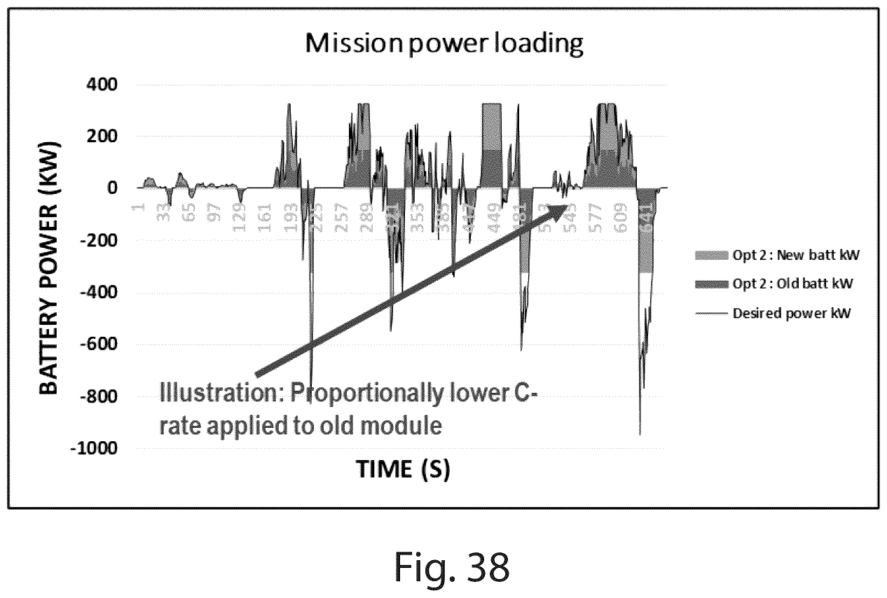

In one embodiment, the pack controller 620 and/or the system controller 640 may be responsible for the critical decision on power split between the modules. Such a power split can be seen and illustrated embodiment of FIG. 38, which depicts power split controls between different modules 800 of differing capabilities. The split may be due to differences in aging, e.g., degradation, or differences in chemistries. However, providing the main power demand through the combined efforts of different modules 800 may involve governing output from each module 800 based on targets (which may be optimally determined for each module 800).

Each module 800 may provide a measure of its SOH and SOP. The combined measure of the system SOP may be the sum of the individual module SOPs. However, when a power command is received (e.g., a vehicle wheel power command), power can be split between various sources based on not only what is available at each source, but also the impact of the power load. The split determination among the sources (e.g., the modules 800) can be based on several possible cost functions, including but not limited to: 1) minimize the total impact to SOH; 2) controlled decay of SOH, so that each module can achieve end of life (EOL) in about the same timeframe; 3) controlled SOH decay, so that the total cost of health degradation is minimized, e.g., different modules may have different prices and this approach will favor more expensive modules so that the $/percent loss in SOH for the overall EESS is minimized; and 4) maximize residual power levels through SOC control, so that higher power residual capability remains in the overall pack/battery, or a combination thereof.

The pack controller 620 may be configured to charge balance between modules 800 of differing chemistry and age. This can be conducted by throttling the charge flow based on the specific characteristics of both the recipient modules 800 and the modules 800 based on power and charge limits. This also can be conducted by monitoring throughput impact to age, e.g., degradation, so that based on a cost function, the amount of total energy being moved may be controlled. This also can be adjusted during plug-in charge conditions.

The pack controller 620 and/or the system controller 640 may be configured to identify when a module 800 is correctly inserted or removed to activate contactors and pre-charging circuit with each. This can be done using active sensing of closed successful insertion or open successful removal of a module 800. The readiness or fault free state of all modules may be analyzed before any of the module output ports are energized. This can be conducted and/or confirmed for charging or discharging.

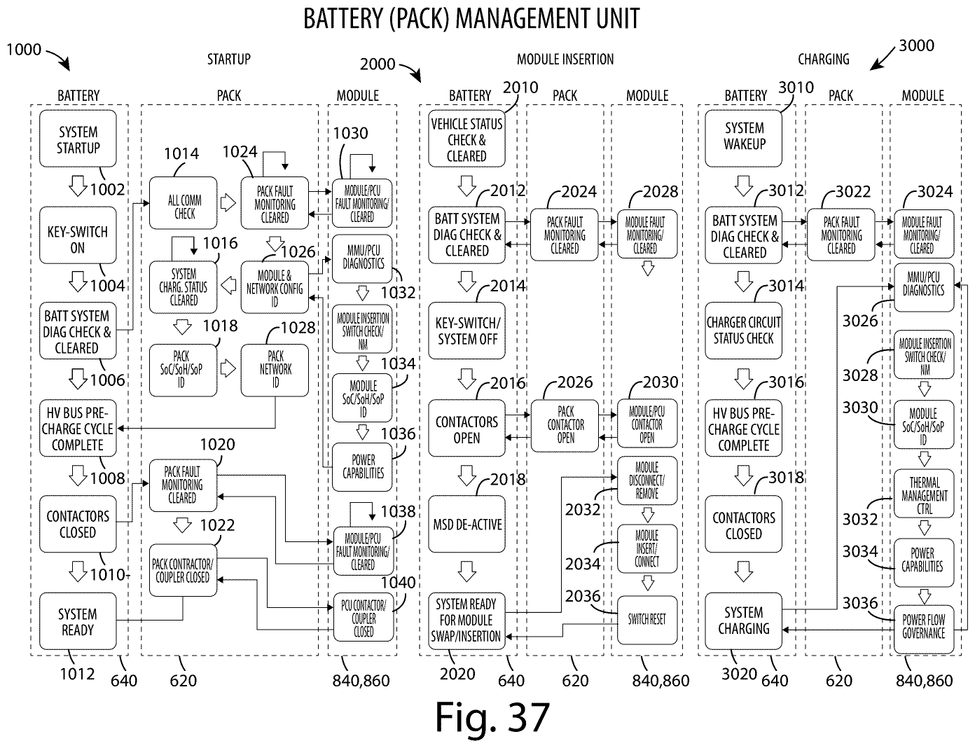

In the illustrated embodiment of FIG. 37, several modes of operation and associated control methods are depicted. The methods depicted in the illustrated embodiment relate to operational aspects of the module controller 840, the pack controller 620, and the system controller 640 for different modes of operation. It is noted that the present disclosure is not limited to the methodology depicted in the illustrated embodiment. One or more steps described in conjunction with one controller may be provided in another of the controllers.

A method for startup is shown in the illustrated embodiment and designated 1000. The method involves the system controller 640 conducting system startup, key switch on analysis, and battery system diagnostic analysis. Steps 1002, 1004, 1006. The pack controller 620 may conduct a communications check, fault monitoring, charging status analysis, and module and network configuration identification. Steps 1014, 1016, 1024, 1026. The pack controller 620 may further conduct an analysis of pack state of charge, state of health, and state of power, and determine a packet network identification. Steps 1018, 1028.

The system controller 640 may receive the PAC network identification from the pack controller 620 and determine a high voltage bus pre-charge cycle is complete. Step 1008. The system controller 640 may direct closing of contacts for the pack 810 or determine that the contacts of the pack 810 are closed, and then determine that the system is ready. Steps 1010, 1012. As part of the process associated with the contact and system ready steps 1010, 1012 of the system controller 640, the pack controller 620 may determine pack faults are being monitored and/or cleared, and that the pack contactors and/or couplers are closed. Steps 1020, 1022.

The module controller 840 may operate in conjunction with the pack controller 620 and the system controller 640 during startup. The module controller 840 may conduct analysis of module monitoring for faults and clearing with respect to the same. Step 1030. The module controller may also conduct controller diagnostics, and conduct a check with respect to module and certain switches. Steps 1032, 1034. The module controller 840 may determine state of charge, state of health, and state of power, and optionally identification with respect to the same. Step 1034. Additionally, the module controller 840 may determine power capabilities of the module 800. Step 1036. The module controller 840 may also conduct analysis with respect to fault monitoring and clearing, and control over contactors and/or couplers to determine a state with respect to the same (e.g., a closed status). Steps 1038, 1040.

A method of inserting a module 800 according to one embodiment is generally designated 2000 in the illustrated embodiment. The method 2000 may include, at the system controller 640, determining that a vehicle status check has been conducted and cleared, as well as a battery system diagnostic check. Steps 2010, 2012. The method 2000 may include determining a key and system are off, Step 2014, and determining contactors are open 2016. The pack controller 620 and the module controller 840 may determine that pack faults are being monitored and are clear, and that module faults are being monitored and cleared. Steps 2024, 2028. Additionally, the pack controller 620 and the module controller 840 may determine that pack contactors are open and that module contactors are open. Steps 2026, 2030.

The system controller 640 may conduct deactivation of a master service disconnect (MSD) and identify that the system is ready for a swap or insertion of a module 800. Steps 2018, 2020. As part of this process, the module controller 840 may be directed to disconnect or remove a module 800, insertion or connection of a module 800, and conduct a switch reset. Steps 2032, 2034, 2036.

A method of charging a module 800 according to one embodiment is generally designated 3000 in the illustrated embodiment. The system controller 640 may wake up and initiate a system diagnostic check and determine that the check has cleared. Steps 3010, 3012. The diagnostic check may involve for monitoring at the pack 600 and the module 800. Steps 3022, 3024. After the system controller 640 has determined the diagnostic check is satisfactory, it may conduct a status check with respect to the charter circuit. Step 3014. A pre-charge cycle with respect to the high voltage bus (e.g., main bus 36) may be conducted. Step 3016, and contactors (e.g., switches or relays) may be closed. Step 3018. The system controller 640 may initiate system charging procedures, which may include diagnostics at step 3026, confirmation of module insertion at step 3028, identification of the state of charge, state of health, and/or state of power past step 3030, and control over thermal management step 3032. The module controller 140 may assess power capabilities of the module 800 and determine governance over power flow. Steps 3034, 3036.

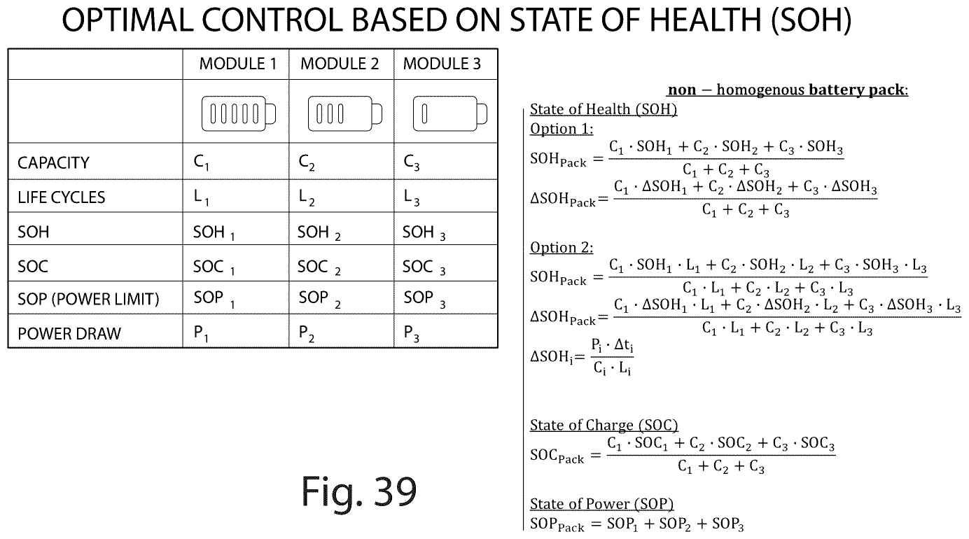

A control methodology according to one embodiment is depicted in FIG. 39 and shown based on SOH. The control methodology may provide a mechanism for power demand split between the various modules 800 that are available in the system.

In a conventional battery system, the power split may be done uniformly across all storage modules up to the power limit of the module. The power limit of the module is referred to as the SOP.

In one embodiment of the present disclosure, the power split may be configured to to provide greater capability to the end-users while better protecting the system 600. In addition to the features described in FIGS. 29, 30, and 35, the pack controller 620 and/or the system controller 640 may provide methods for describing the SOH/SOC/SOP of the overall pack 610 based on the individual SOH/SOC/SOP of each module 800, as depicted in FIG. 39.

The calculations and methodologies depicted in FIG. 39 are provided for the purposes of disclosure, so that the system 600 is not limited to these specific calculations and methodologies. Conventional algorithms that are often used to determine the SOH/SOC/SOP of a module 800 may still apply, however translating this type of information to the level of a pack 610 may involve several differences over conventional approaches.

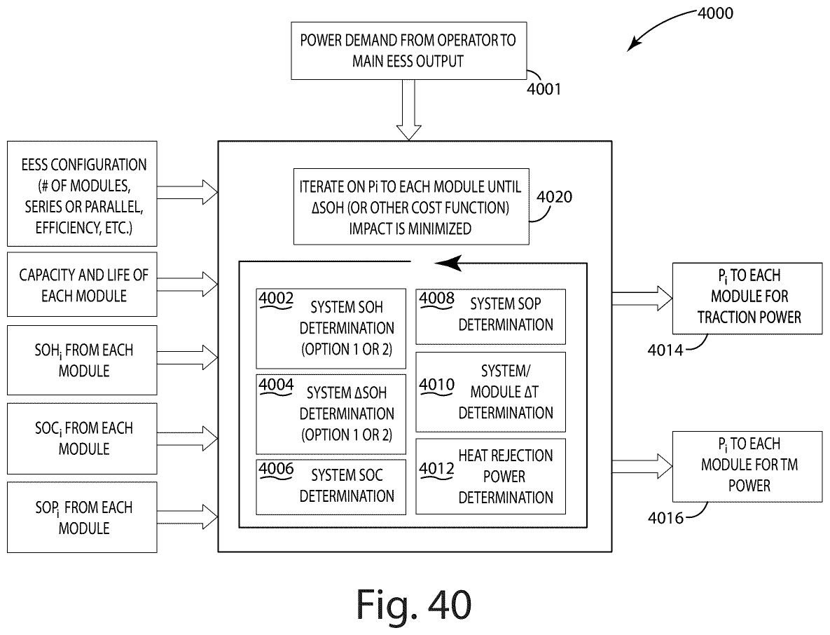

A method according to one embodiment for control over power from one or more modules 800 is shown in FIG. 40 and designated 4000. As described herein, each module 800 may provide a measure of its SOH and SOP. The combined measure of the system SOP may be the sum of the individual module SOPs. However, when a power command is received (e.g., a real power command), power can be split between various sources based on not only what is available at each source but also the impact of the power load. Step 4001. The power split can be provided for traction power and/or thermal management. Steps 4014, 4016.

The system SOH, SOP, delta T, and heat rejection may be determined with respect to each module 800 in an iterative manner. Steps 4002, 4004, 4006, 4008, 4010, 4012. This process may be conducted iteratively on each module 800 until a change in SOH (or another cost function alternative or in addition to SOH) can be reduced or minimized. Analysis may be conducted in terms of the impact of SOH lost for a multi-chemistry/multi-aged, e.g., degraded, EESS. Several embodiments of this may be established, with features including:
minimizing the total impact to pack SOH based on SOH of each module; and/or
defining pack SOH according to one of the following of option 1 or option 2.

Option 1 may provide a weighted sum of individual module SOH based on capacity of each module 800 to provide the pack SOH. Thus, larger modules, e.g., greater energy density cells, may be given more weight in the analysis.

Option 2 may provide not only weighting based on the capacity of each module 800, but also the expected cycle life of each module. Thus, modules 800 with high cycle life may be given more weight.

In practice, both these options can be used together by linearly or non-linearly scaling these to create a SOH for the pack 600 e.g., SOHpack=(α)*SOH_{pack}^{option 1}+(1−α)*SOH_{pack}^{Option 2}.

Power split can be achieved by minimizing the ΔSOH of the pack 610 at each time step. Optionally, power split can be achieved by minimizing the total ΔSOC of the pack 610 at each time step.

When power splits results in power limits being reached for some modules 800, then the algorithm may re-optimize for the remaining modules 800 that have not reached their power limits.

Power requirements for thermal management may also be captured in the analysis. Optimizations may consider this power draw from each module 800 for powering either their dedicated thermal management system 810 or providing power to another module 800 to support its thermal management system 810.

The methodology for splitting power may also consider the efficiency with which the power is being moved in/out of each module 800. Thus, not only would this impact the thermal management system 810 power requirements, but it would also impact the wasted power being consumed by the system 600. By considering the efficiency of the power flow, the cost function can be configured to minimize losses as well. This can be competing with the ΔSOH impact to the overall pack 610.

One embodiment according to the present disclosure may provide a flexible electrical energy storage solution (EESS) for commercial vehicles near-zero/zero emission powertrain architectures that support mission diversity, while maintaining high vehicle up-time, efficiency and lowering the burdened cost to the end-customer. For conventional fleets, the modular power system 600 according to one embodiment may lower the burden of each vehicle's energy storage, e.g., first-fit sized for the most energy intensive missions or 90-95 percentile. Instead, users can add/subtract energy storage modules 800 to/from each vehicle 10 as suitable for the upcoming mission. Users can benefit in charging the modules 800 off-board the vehicles 10, increasing vehicle availability and efficiency, reducing carbon footprint, and reducing grid demand charges.

In one embodiment, users may optimize, e.g., “right size” and “right chemistry”, the modular power system 600 for an application using a system architecture and technoeconomic tool.

In one embodiment, the modular power system 600 may enable durable and rapid insertion/removal of modules 800 based on wireless power transfer, potentially avoiding repeated insertion and removal of modules 800 that cause significant wear and consumption of time.

In one embodiment, modules may be charged on- or off-board the vehicle 10, thereby increasing vehicle availability.

In one embodiment, the modular power system 600 may be reconfigurable, which can increase cost for supporting equipment over conventional architecture. Such additional costs at the system level TCO for the reconfigurable system can be offset by one or more of the following:

A customer specific metric may be used to define the architecture and value proposition. The customer metric may correspond to a variety of customer related information, such as total cost of ownership, system cost, performance, or another technoeconomic factor that impacts the customer's decision around technology. This metric may be used by a customer to determine what is their ideal choice and it may vary by location and with time. The customer may also consider a metric, such as a long-term choice implications, to lock down their final choices.

Total fleet energy storage requirements may be optimized, e.g., total number of assets for the modular power system 600 may be reduced.

Off-board recharging in the modular power system 600 may allow grid demand charge minimization.

An increase in grid resiliency/decarbonization may be provided with “stationary” energy storage.

Increased productivity, e.g., freight efficiency, may be provided by “right sizing” and “right chemistry”.

In one embodiment the modular power system 600 may be used in a variety of fields, including but not limited to transportation, energy, and utilities. Also more specifically, commercial applications include all commercial class vehicles that are operated as a fleet and experience variations in their day-to-day use-cases. The vehicles can have some depot to support module 800 removal and replacement, as well as off-board charging capabilities. The value proposition is expected to be better for fleet operators rather than a single owner-operator.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A modular DC-power source to be placed within, and removed from, a DC-power slot of an electric vehicle (EV) for controlling a range of the EV, the EV including a DC bus that has a wireless input port associated with the DC-power slot, the wireless input port being formed from an input wireless power transfer (WPT) pad electrically coupled with an AC/DC rectifier, the modular DC-power source comprising:
a DC-power source configured to output first DC power;
a high-frequency inverter electrically coupled with the DC-power source and configured to convert the first DC power to high-frequency AC power;
an output WPT pad electrically coupled with the high-frequency inverter and arranged to be located adjacent to, but spaced apart from, the input WPT pad of the wireless input port of the DC bus when the modular DC-power source has been placed within the DC-power slot, the output WPT pad being configured to wirelessly transmit the high-frequency AC power to the adjacently located input WPT pad to be converted to second DC power by the AC/DC rectifier of the wireless input port, the second DC power being provided to the DC bus by the AC/DC rectifier;
a power conditioning subsystem configured to regulate the transmitted high-frequency AC power based on, at least in part, the first DC power available to be output by the battery and the DC power provided to the DC bus by the one or more DC power sources coupled to the DC bus.

2. The modular DC-power source of claim 1 comprising a thermal management subsystem with an integrated cooling system configured to reject heat released by components of the modular battery and by the one or more DC power sources coupled to the DC bus.

3. The modular DC-power source of claim 1, wherein the DC-power source is a battery.

4. The modular DC-power source of claim 1, wherein the DC-power source is a fuel cell.

5. The modular DC-power source of claim 1, wherein the DC-power source is a DC-power generator that includes:
an AC-power generator driven by an internal combustion engine to produce AC power, and
a rectifier electrically coupled to the AC-power generator to convert the AC power to the first DC power that is output by the DC-power source.

6. The modular DC-power source of claim 1, comprising a frame configured and shaped to encompass the DC-power source at least partially, wherein the output WPT pad is disposed on one of the sides, top, or bottom of the frame.

7. The modular DC-power source of claim 1, comprising a module management subsystem configured to control operation of the high-frequency inverter and operation of at least one of the power conditioning subsystem and a thermal management subsystem.

8. A pack comprising:
two or more modular batteries according to claim 1, the modular batteries being at least some of the DC power sources coupled to the DC bus to provide DC power thereto, wherein each module management subsystem of a respective modular battery of the pack is configured to communicate with module management subsystems of remaining modular batteries that are currently part of the pack; and
a pack management subsystem communicatively coupled with the module management subsystems of the modular batteries that are currently part of the pack, the pack management subsystem configured to:
receive modular battery specific telemetric information from the pack's module management subsystems,
issue, based on the modular battery specific telemetric information received on a collective basis, commands for operating the pack's module batteries, and
transmit the commands on an individual basis to the pack's module management subsystems.

9. The pack of claim 8, wherein the modular battery specific telemetric information comprises state of health, state of charge and state of power, and the pack management subsystem is configured to:
determine state of health, state of charge and state of power for the pack, and
issue the commands using the determined pack specific information.

10. The pack of claim 9, wherein, to determine the pack specific information, the pack management subsystem is configured to combine the modular battery specific telemetric information.

11. The pack of claim 8, comprising at least one fixed battery module that is coupled to the DC bus, in a manner that renders the fixed battery module un-swappable, to provide DC power thereto, wherein the fixed battery module comprises a rechargeable battery.

12. A reconfigurable electrical energy storage system (EESS) to be disposed onboard a vehicle, the EESS comprising:
two or more packs according to claim 8, the modular batteries of the packs being the DC power sources coupled to the DC bus to provide DC power thereto, wherein each pack management subsystem of a respective pack of the EESS is configured to communicate with pack management subsystems of remaining packs that are currently part of the EESS; and
an EESS management subsystem communicatively coupled with the pack management subsystems of the packs that are currently part of the EESS, the EESS management subsystem configured to:
receive pack specific information from the EESS' pack management subsystems, issue, based on the pack specific information received on a collective basis, commands for operating the EESS' packs, and
transmit the commands on an individual basis to the EESS' pack management subsystems.

13. A modular DC-power source to be placed within, and removed from, a DC-power slot of an electric vehicle (EV) for controlling a range of the EV, the EV including a DC bus that has a wireless input port associated with the DC-power slot, the wireless input port being formed from an input wireless power transfer (WPT) pad electrically coupled with an AC/DC rectifier, the modular DC-power source comprising:
a DC-power source configured to output first DC power;
a high-frequency inverter electrically coupled with the DC-power source and configured to convert the first DC power to high-frequency AC power;
an output WPT pad electrically coupled with the high-frequency inverter and arranged to be located adjacent to, but spaced apart from, the input WPT pad of the wireless input port of the DC bus when the modular DC-power source has been placed within the DC-power slot, the output WPT pad being configured to wirelessly transmit the high-frequency AC power to the adjacently located input WPT pad to be converted to second DC power by the AC/DC rectifier of the wireless input port, the second DC power being provided to the DC bus by the AC/DC rectifier;
a thermal management subsystem with an integrated cooling system configured to reject heat released by components of the modular battery and by the one or more DC power sources coupled to the DC bus.

14. The modular DC-power source of claim 13, comprising a power conditioning subsystem configured to regulate the transmitted high-frequency AC power based on, at least in part, the first DC power available to be output by the battery and the DC power provided to the DC bus by the one or more DC power sources coupled to the DC bus.

15. The modular DC-power source of claim 13, wherein the DC-power source is a battery.

16. The modular DC-power source of claim 13, wherein the DC-power source is a fuel cell.

17. The modular DC-power source of claim 13, wherein the DC-power source is a DC-power generator that includes:
an AC-power generator driven by an internal combustion engine to produce AC power, and
a rectifier electrically coupled to the AC-power generator to convert the AC power to the first DC power that is output by the DC-power source.

18. The modular DC-power source of claim 13, comprising a frame configured and shaped to encompass the DC-power source at least partially, wherein the output WPT pad is disposed on one of the sides, top or bottom of the frame.

19. The modular DC-power source of claim 13, comprising a module management subsystem configured to control operation of the high-frequency inverter and operation of at least one of the power conditioning subsystem and a thermal management subsystem.

20. A pack comprising:
two or more modular batteries according to claim 13, the modular batteries being at least some of the DC power sources coupled to the DC bus to provide DC power thereto, wherein each module management subsystem of a respective modular battery of the pack is configured to communicate with module management subsystems of remaining modular batteries that are currently part of the pack; and
a pack management subsystem communicatively coupled with the module management subsystems of the modular batteries that are currently part of the pack, the pack management subsystem configured to:
receive modular battery specific telemetric information from the pack's module management subsystems,
issue, based on the modular battery specific telemetric information received on a collective basis, commands for operating the pack's module batteries, and
transmit the commands on an individual basis to the pack's module management subsystems.

21. The pack of claim 20, wherein the modular battery specific telemetric information comprises state of health, state of charge and state of power, and the pack management subsystem is configured to:
determine state of health, state of charge and state of power for the pack, and
issue the commands using the determined pack specific information.

22. The pack of claim 21, wherein, to determine the pack specific information, the pack management subsystem is configured to combine the modular battery specific telemetric information.

23. The pack of claim 20, comprising at least one fixed battery module that is coupled to the DC bus, in a manner that renders the fixed battery module un-swappable, to provide DC power thereto, wherein the fixed battery module comprises a rechargeable battery.

24. A reconfigurable electrical energy storage system (EESS) to be disposed onboard a vehicle, the EESS comprising:
two or more packs according to claim 20, the modular batteries of the packs being the DC power sources coupled to the DC bus to provide DC power thereto, wherein each pack management subsystem of a respective pack of the EESS is configured to communicate with pack management subsystems of remaining packs that are currently part of the EESS; and
an EESS management subsystem communicatively coupled with the pack management subsystems of the packs that are currently part of the EESS, the EESS management subsystem configured to:
receive pack specific information from the EESS' pack management subsystems,
issue, based on the pack specific information received on a collective basis, commands for operating the EESS' packs, and
transmit the commands on an individual basis to the EESS' pack management subsystems.
